(19) United States
(12) Patent Application Publication
(10) Pub. No.: US 2013/0339127 A1
(43) Pub. Date: Dec. 19, 2013

(54) INTERPERSONAL TIMING IN AD RANKING

(71) Applicant: William J. PLUT, Los Altos, CA (US)

(72) Inventor: William J. PLUT, Los Altos, CA (US)

(73) Assignee: TRUSTEDAD, INC., Menlo Park, CA (US)

(21) Appl. No.: 13/524,940

(22) Filed: Jun. 15, 2012

(51) Int. Cl. G06Q 30/02

(52) U.S. Cl. 705/14.42; 705/14.4

(57) ABSTRACT

An interpersonal electronic advertising system is described. The system is configured to enable an ad suggester to create and send an interpersonal ad for a product or service to an ad recipient. The interpersonal ad can lead to a purchase of the product or the service by the ad recipient and in response the system can compensate the ad suggester. In particular embodiments, the system can be configured to output one or more interpersonal ads to an ad recipient at any one time. The amount of ads that can be output at a time can be limited to a particular number where a number of available interpersonal ads is greater than the particular number. The system can be configured to rank the available interpersonal ads and output the better ranking interpersonal ads first.

### FIELD OF THE INVENTION

This invention generally relates to electronic advertising and digital social sales, and more particularly to systems and methods that provide rankings for interpersonal electronic advertisements.

### BACKGROUND

Advertising plays a central role in selling numerous products and services. Prior online advertisement providers use automated tools to send an advertisement to a person based on demographic characteristics and past contextual knowledge of the recipient, such as the online traffic content, or using information gathered from Internet searches, email content, or location detection technology.

For a number of reasons, these automated forms of advertisement based on prior online data suffer from a relatively low ratio of conversion into actual purchases. First, online users are inundated with irrelevant advertisements that collectively desensitize a viewer because the advertisements are based on outdated data and no longer relevant to their changing needs. Advertisements frequently show a product that has already been purchased. A person's needs change. For example, if an Internet user builds a car online at a car manufacturer's site, then the person will continue to receive ads for that car, irrespective if they actually liked the car, or whether they found a better car. More importantly, some advertisement providers selfishly display ads according to their highest paying advertiser. This is clearly not in the best interest of a particular ad recipient.

Based on the foregoing, there is a need for systems and methods for improved electronic advertising.

### BRIEF DESCRIPTION OF THE DRAWINGS

FIG. 1 illustrates a system for sending an interpersonal electronic advertisement in accordance with the described embodiments.

FIG. 2 illustrates a flow chart of a method for sending a suggested electronic advertisement and attributing compensation in accordance with the described embodiments.

FIG. 3 illustrates a graphical user interface for displaying a viewable page including one or more interpersonal ads in accordance with the described embodiments.

FIG. 4 illustrates a block diagram for a process including interpersonal ad ranking in accordance with the described embodiments.

FIGS. 5A, 5B and 5C are graphs of functions that can be used to effect a rank value determination as a function of time in accordance with the described embodiments.

FIG. 6 is a graph of a function that can be used to effect a rank value determination as a function of Ad clicks in accordance with the described embodiments.

FIGS. 7A, 7B and 7C are graphs of rank value determinations as a function of time in which an ad suggestion effectiveness metric is varied in accordance with the described embodiments.

FIGS. 8A and 8B are graphs of rank value determination as a function of time where the rank value determination for an interpersonal ad is varied according to an ad click or an ad purchase.

FIG. 9 is flow chart of a method for outputting interpersonal ads via an output interface.

FIG. 10 illustrates a network in which systems and methods consistent with the principles of the invention may be implemented.

FIG. 11 illustrates a sample computer system suitable for implementing some embodiments described herein.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As described herein, embodiments of interpersonal electronic advertising methods and systems leverage information about an intended advertisement recipient (or ‘intended recipient’, or ‘ad recipient’, or ‘recipient’) learned by an electronic advertisement suggester (or ‘ad suggester’ or ‘suggester’). For example, a person may tell their co-worker in an email that they need to buy a camera. The interpersonal electronic advertisement system enables the ad suggester to use information about the ad recipient to select and send interpersonal electronic advertisements, or interpersonal ads, to the ad recipient. The system enables the ad suggester to be compensated when the recipient activates the ad.

An activation of the ad can involve the ad recipient completing a purchase associated with the advertisement. For instance, via a user interface, the ad recipient can select an ad received created ad suggester. The ad can advocate a particular product or service. After selecting the ad, the interface can be reconfigured to allow the ad recipient complete the purchase. After the purchase is completed the ad suggester can be compensated.

The purchase described in the previous paragraph is more likely to be completed as compared to current electronic advertising system because the ad recipient can have a relationship with the ad suggester that involves the sharing of current and trusted consumer information. In view of this knowledge, the ad suggester can use the system to send timely and relevant ads to the recipients, which have a high likelihood of action by the recipient. It is believed that in many situations the likelihood of action by the recipient will be much higher than current electronic advertising systems. With higher likelihood of action, the ad suggester can be compensated at a much higher rate than current electronic advertising systems afford.

In many instances, the consumer information will pass from the ad recipient to the ad suggester via their interpersonal communications. The interpersonal communications can involve direct, face-to-face communications or electronic methods, such as voice, instant messaging, text, email, or twitter feed, where an electronic device is employed to enable the communication. As an example, in a text or in a face to face conversation an ad recipient can tell the ad suggester that they desire to purchase a product or service in the near future. In other instances, the ad suggester can also obtain consumer information associated with the ad recipient by indirect methods. For example, the ad suggester can obtain consumer information associated with the ad recipient through observation of preferences expressed in previous purchases made by the ad recipient or through the observation of the ad recipient's interaction with other individuals besides the ad suggester. In either case, the ad suggester now has personal and intimate and timely consumer information relating to a consumer need for the ad recipient.

With the consumer information, the ad suggester can use the system described herein to create an interpersonal electronic advertisement for provision to the ad recipient. Creation of an interpersonal ad typically includes a) indication of an ad recipient for the ad, and b) selection or suggestion of a product or service. For example, a man tells his cousin that he is planning a trip and needs to purchase new luggage. This is sufficient information for the cousin to use the interpersonal electronic advertising system to create and send the man an advertisement featuring a particular brand and model of luggage. The cousin may select the particular brand and model based upon additional consumer information the cousin knows about the man, such as how much he typically spend on items, whether he tends to pack a lot, or what type of luggage the man prefers. The man can favorably receive the ad because 1) it arrives from a trusted source with timely knowledge, 2) it is personalized to his preferences and 3) the man is aware the cousin will be compensated if he purchases the luggage via the ad provided through the system.

In contrast, to the system described in the previous paragraph, a context based electronic advertising system is much more “hit” or “miss.” For instance, the man in the example above might do a search related to their upcoming trip. In response, a context based advertising system might serve up an ad related to travel products. A number of travel product suppliers may bid to have their ad shown first to the man, such as an airline or hotel. If a luggage provider is in the bidding and bids high enough amidst the hundreds of other merchants, then the man may see a luggage advertisement. If the man has not already purchased luggage and the man trusts the source of the ad, then the man may consider selecting the ad and possibly completing a purchase. Thus, in a context based advertising system, the odds of providing a timely and on-point ad to man, such as an ad targeting a desired consumer need of the man that has not already been fulfilled is likely to be much lower than with the systems and methods described herein.

Further, because of the “hit” or “miss” nature of context based electronic advertising systems, a high proportion of electronic ads displayed to a user of such systems are irrelevant. This conditions the user to generally ignore ads. Thus, the likelihood of acting on future ads is also diminished. It is believed with the interpersonal electronic advertising system described herein ads of a more relevant nature will be delivered more consistently than other electronic advertising systems. This is particularly evident when the interpersonal ad conspicuously displays an ad sender that is known the ad recipient—the recipient is much more responsive to the ad. For example, a man may tune out hundreds of context based electronic ads with no downside; he cannot ignore interpersonal ads created by his wife so easily. Thus, it is believed participants in the interpersonal electronic advertising system will drive much better ad reception, and won't engender as much of the negative conditioning that occurs with other electronic advertising systems.

In some implementations, the interpersonal electronic advertising system can include one or more servers coupled to a network. An ad suggester can access the server via one of their personal electronic devices, such as a home computer or mobile device. The server can be configured to generate an interface for an ad suggester on their device that includes electronic advertisement data. Via the interface, the server is configured to receive electronic advertisement input (or a ‘suggestion’) from the ad suggester to create an ad for an ad recipient. In response to the user input, the server can send an interpersonal electronic advertisement to the ad recipient.

Via the interpersonal electronic systems described herein, interfaces can be provided where an ad suggester or an ad recipient can view a number of different interpersonal ads. The interpersonal ads created and viewed by an ad suggester can be sent to various ad recipients. The interpersonal ads viewed by an ad recipient may have been sent from one or more different ad suggesters. In one embodiment, the interface is associated with a social network profile page of an ad suggester. The system can be configured to serve a visitor to the page interpersonal ads selected by the ad suggester specifically for the visitor.

The system can include logic for determining a rank value for a group of interpersonal ads that can be viewed by an ad suggester or an ad recipient in an interface. The system can be configured to control the output of the group of interpersonal ads to the interface such that interpersonal ads that are more highly ranked according to their rank value are more likely to be output to the interface and possibly displayed more prominently in the interface than interpersonal ads less that are less highly ranked.

The rank value for a particular interpersonal ad that is to be viewed by an ad recipient can be determined to account for the consumer influence that the ad suggester has over the ad recipient. Typically, an interpersonal ad will become more highly ranked as the consumer influence increases for the ad suggester over an ad recipient. One factor for estimating the consumer influence of an ad suggester to an ad recipient is referred to as an ad suggestion effectiveness metric.

Besides consumer influence, a number of factors can be utilized to determine a rank value for an interpersonal ad. These factors can include: a total ad commission associated with the interpersonal ad, whether the ad recipient of the interpersonal ad has previously acknowledged the interpersonal ad, such as via a “click” in an interface and whether a purchase has been previously initiated from the interpersonal ad by the ad recipient. In particular embodiments, which are described in more detail with respect to the figures below, the interpersonal electronic advertising system can be configured to output interpersonal ads to ad suggesters and ad recipients in accordance with the rank values determined for the interpersonal ads.

One aspect of the embodiments described herein can be related to a method for outputting electronic interpersonal ads in an electronic advertising system. The method can be generally characterized as including 1) receiving in a processor selections of a plurality of different interpersonal ads from a plurality of different ad suggesters; 2) determining in the processor a first set of interpersonal ads from the plurality of different interpersonal ads to output to a first ad recipient; 3) determining in the processor, for each interpersonal ad in the first set, a value of a time measure; 4) determining in the processor, for each interpersonal ad in the first set, a rank value based upon at least the determined value of the time measure; and 5) controlling in the processor an output of the first set of interpersonal ads to an electronic interface in accordance with their respectively determined rank values.

Another aspect of the embodiments described herein is related to interpersonal ad ranking in an electronic advertising system. The method can be generally characterized as including receiving in a processor a selection of a interpersonal ad from an ad suggester for an ad recipient; 1) at a first time, determining in the processor a first value of a time measure; 2) determining in the processor a first rank value of the interpersonal ad based upon the first value; 3) outputting the interpersonal ad via an electronic interface in accordance with the first rank value; 4) at a second time, determining in the processor a second value of the time measure; 5) determining in the processor a second rank value of the interpersonal ad based upon the second value; and 6) outputting the interpersonal ad via the electronic interface in accordance with the second rank value.

Techniques and methods described herein can find use with a wide array of electronics devices. For example, desktop and laptop computers are now common and may implement software that permits users to select and send and receive ads. Electronic interpersonal advertising as described herein is also suitable for use with mobile electronic devices such as personal digital assistants (PDAs), cellular telephones, smartphones, portable computer systems, thin clients, portable tablet computers, audio players, among others, because of the inherent portability of such devices.

All or portions of the subject invention may be implemented as a method, apparatus, system or article of manufacture using programming and engineering techniques to produce software, firmware, hardware or any combination thereof to control an electronic device to implement the present invention. The term “article of manufacture” as used herein is intended to encompass a computer program with executable instructions accessible from any computer readable device, carrier, or media. For example, computer readable media can include but is not limited to magnetic storage devices, optical disks, smart cards, flash memory devices among others. Of course, those skilled in the art will recognize many modifications may be made to this configuration without departing from the scope or spirit of the disclosed invention.

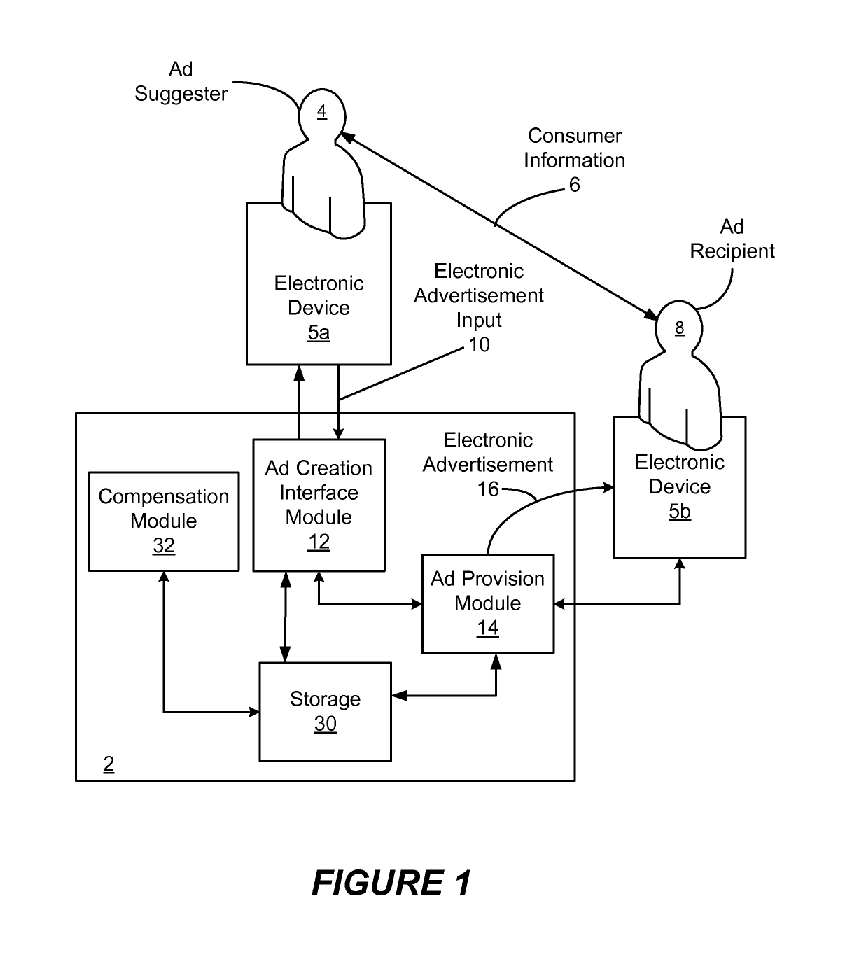

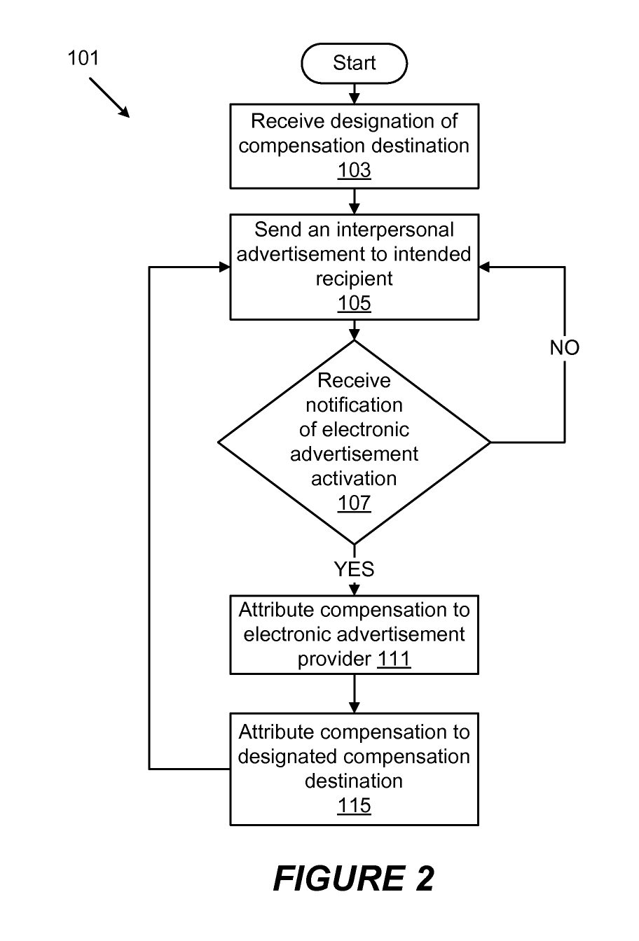

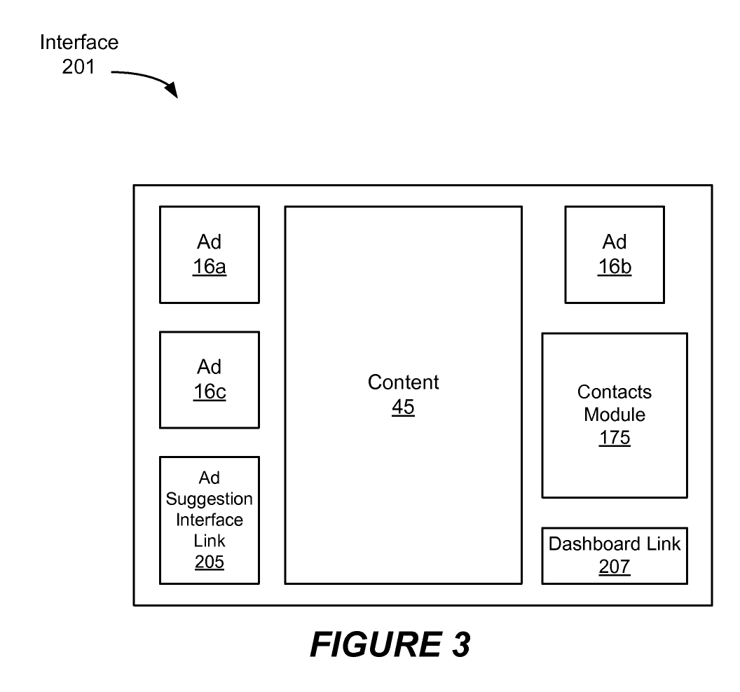

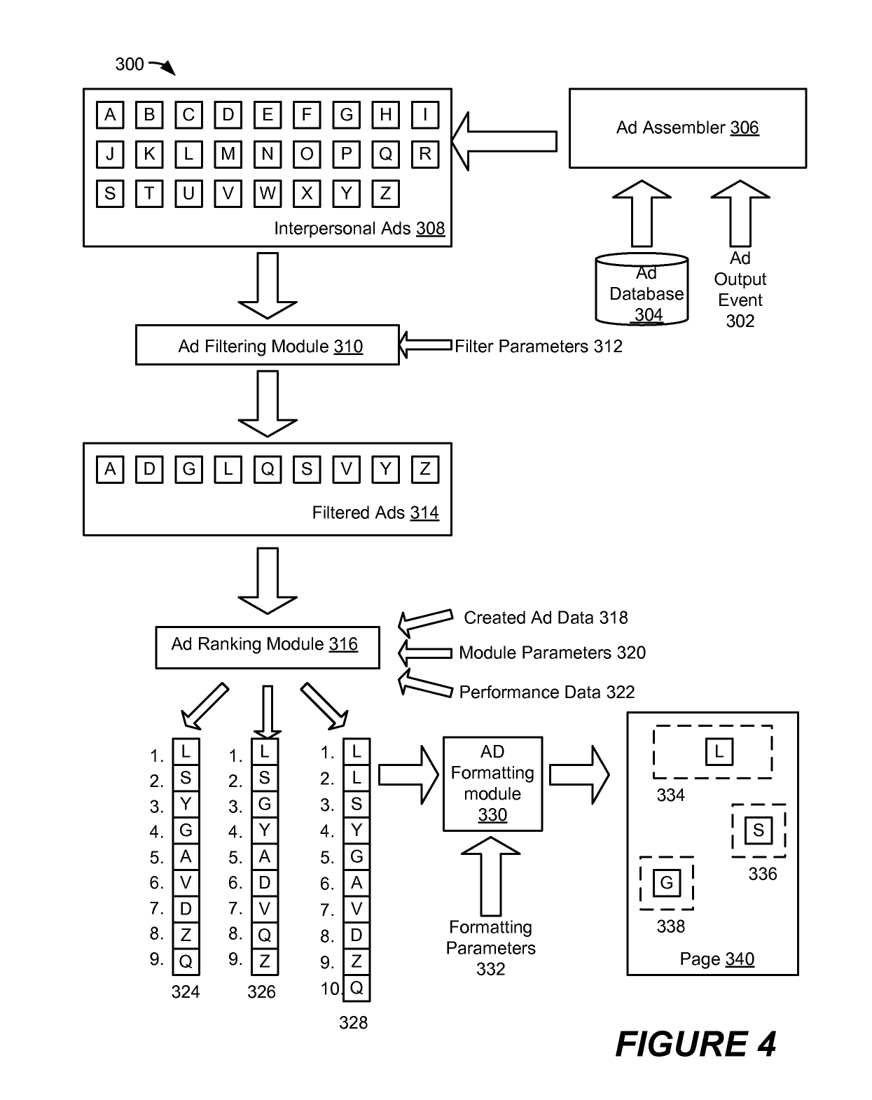

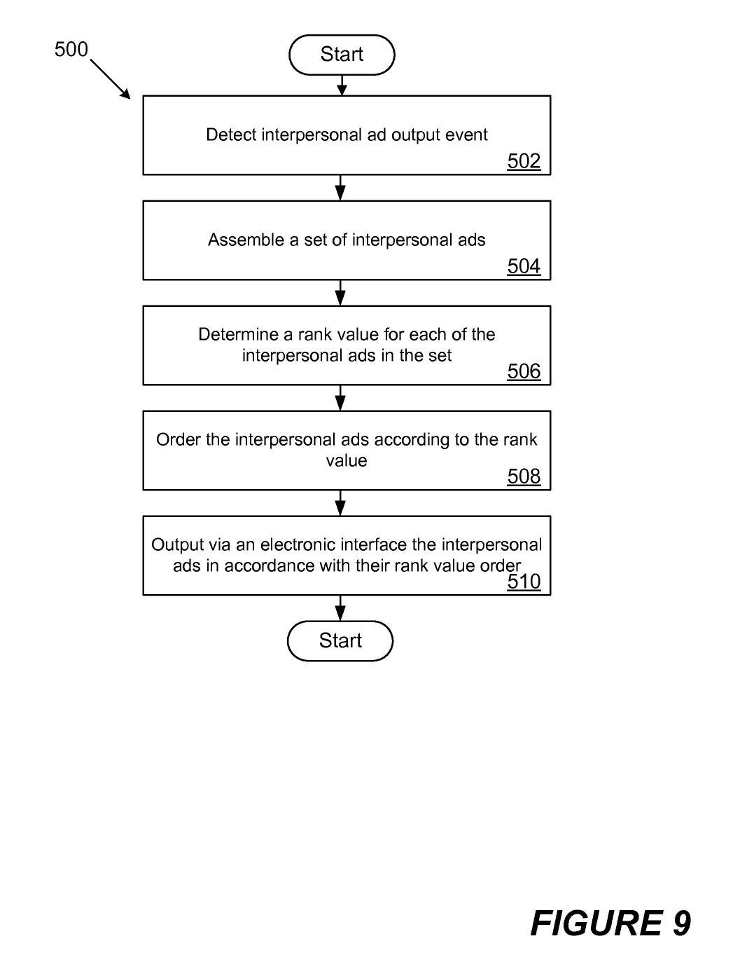

An interpersonal electronic system including ad ranking is described with respect to the following figures and sections. An overview of the interpersonal advertising system is described with respect to FIGS. 1 and 2. In particular, consumer information, creating and sending interpersonal ads based upon the consumer information and compensation for sending interpersonal ads that result in a purchase by an ad recipient are described. In addition, methods for determining for an ad suggester's various ad suggestion effectiveness metrics are described. With respect to FIG. 3, one example of an interface that allows an ad recipient to view interpersonal ads is described. With respect to FIGS. 4 and 9, methods of determining rank value and how rank value can affect the display of a group of interpersonal ads in an interface are discussed.

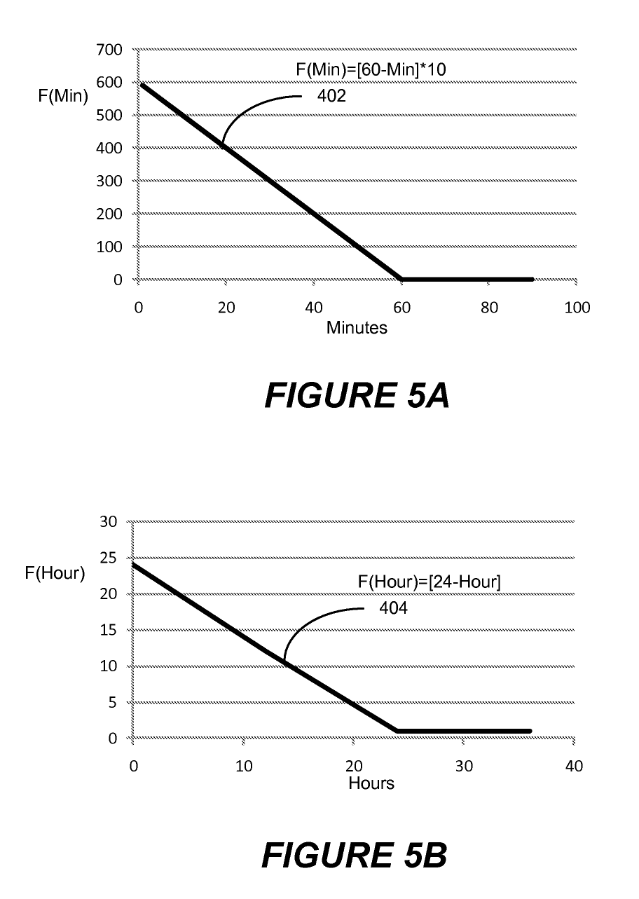

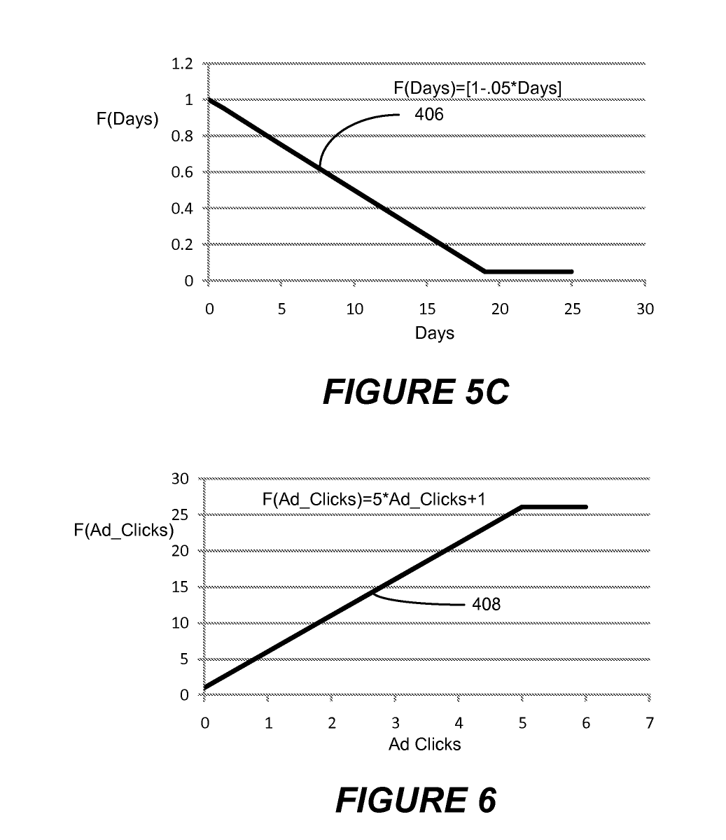

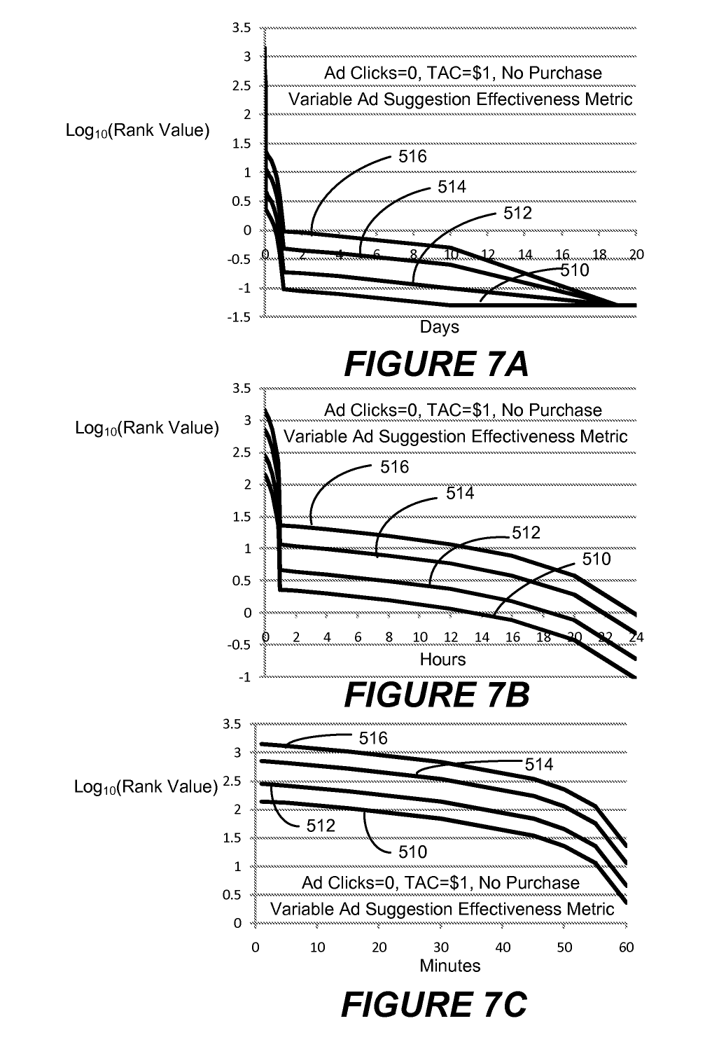

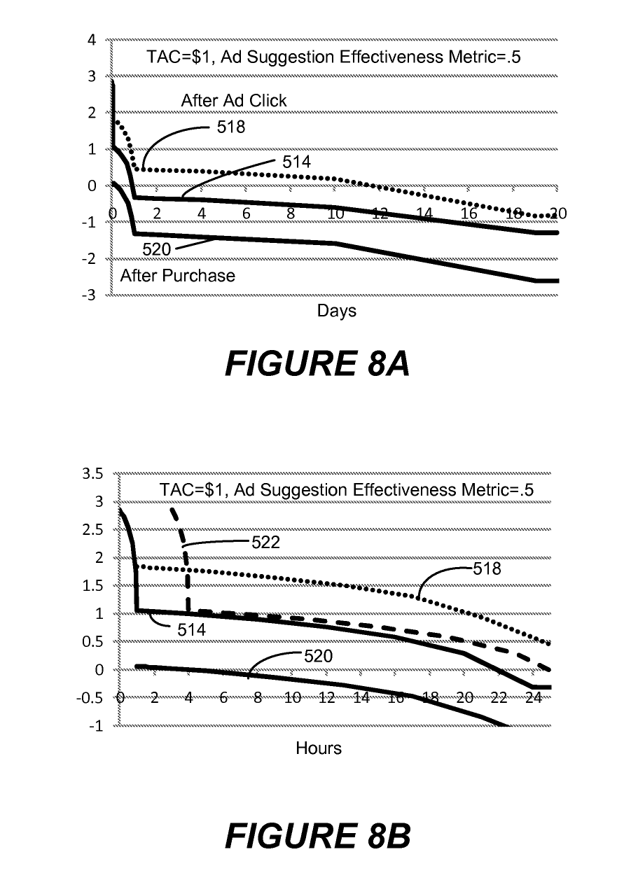

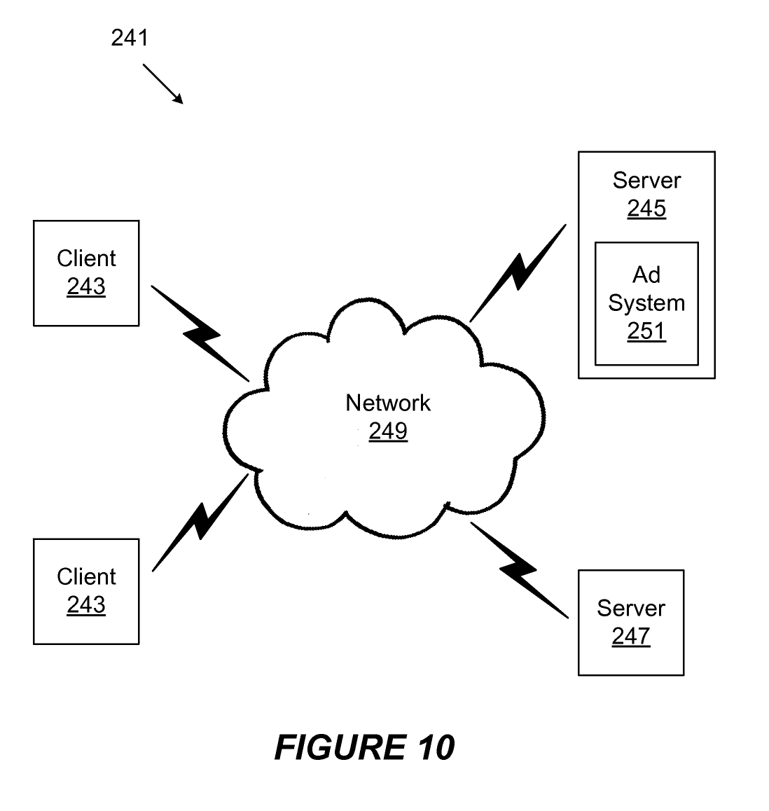

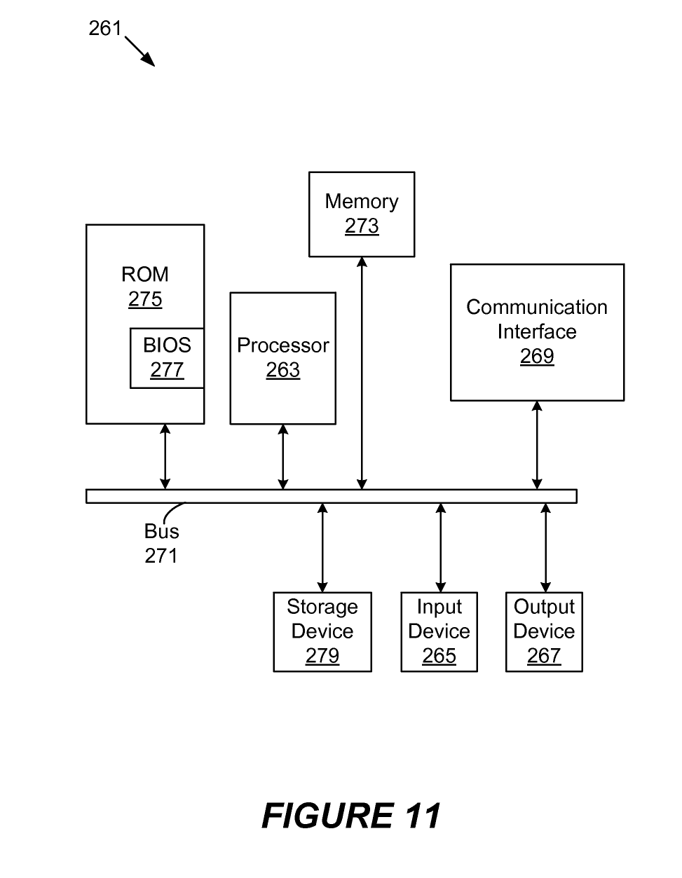

A few examples of functions that can be utilized in a rank value determination are discussed with respect to FIGS. 5A, 5B, 5C and 6. In particular with respect to FIGS. 5A, 5B and 5C functions that affect the determination of rank value as a function of time are described and with respect to FIG. 6 a function that affects the rank value as a function of ad clicks is discussed. With the respect to FIGS. 7A, 7B, 7C, 8A and 8B, an example of determination of rank value as a function of time are described. In particular, the effects of varying a number of parameters within the rank value function are discussed. Finally, system and system components that can be utilized in an interpersonal electronic advertising system including rank value determination are described with respect to FIGS. 10 and 11.

### Interpersonal Electronic Advertising System

FIG. 1 illustrates a system 2 for sending electronic interpersonal advertisements in accordance with one embodiment. System 2 includes an interpersonal advertisement creation interface module 12, interpersonal ad provision module 14, storage 30 and compensation module 32. The system 2 can be configured to interact with numerous electronic devices, such as 5a and 5b. In the example in FIG. 1, electronic device 5a is controlled by an ad suggester 4 and electronic device 5b is controlled by an ad recipient 8.

As described in more detail below, the ad interpersonal interface module 12 can relate to system components that allow an ad suggester to create or suggest an interpersonal advertisement. Whereas, the interpersonal advertisement provision module 14, or ad provision module 14 can refer to any device, system or tool within system 2 configured to send interpersonal ad 16 to intended recipient 8. Data storage 30 can include hardware and/or software for storing information related to system 2. Typically, when the ad suggester 4 creates and sends an ad that leads to a purchase by the ad recipient, compensation is attributed to the ad suggester 4. Compensation module 32 can be configured to attribute an incentive or compensation within interpersonal advertising system. Compensation can refer to any type of incentive, whether monetary, or in another form such as a discount on a present or future consumer transaction, coupon, merchandise, award, products, services, electronic tokens, virtual currency, rebate, among others.

During operation, the system 2 can be configured to interact with a various number of electronic devices where the number of electronic device interacting with the system can vary over time. The system 2 can provide different functions to each of the electronic devices and the functions provided to each device can change over time. For instance, at a first time, individual 8 can engage with system 2 as an ad recipient via device 5b. At a later time, individual 8 can engage with the system 2 as an ad suggester via device 5b. In FIG. 1, for the purposes of illustration, individual 4 is referred to as ad suggester 4 and individual 8 is referred to as an ad recipient 8. However, as noted, at different times the ad suggester 4 can engage system 2 in the role of an ad recipient and the ad recipient 8 can engage the system 2 as an ad suggester.

The system 2 can be configured to establish communication connections with electronic devices, such as 5a and 5b. Via the communication connections, information can be exchanged between the electronic devices and system 2. For example, via device 5a, ad suggester 4 can select and transmit electronic advertisement input 10 to system 2. Further, an ad recipient 8 can view an electronic advertisement 16 suggested by the ad suggester 4 which the system 2 has routed such that it can be viewed on device 5b.

In description to follow, an electronic advertisement suggester 4 (also referred to herein as ad suggester 4, or suggester 4) can refer to any person that possesses consumer information 6 regarding an intended ad recipient 8. Whereas, intended electronic advertisement recipient 8 (also referred to herein as intended recipient 8, or intended electronic advertisement recipient 8, or intended ad recipient 8, or recipient 8) can refer to an intended recipient of an interpersonal (or ‘suggested’) electronic advertisement generated on system 2, such as 16. The advertisement suggester 4 can interact with the system 2 via a client device, such as device 5a to select an ad, such as 16, intended for receipt by the ad recipient 8. Thus, the selected ads are interpersonal ads for the intended ad recipient 8 by the ad suggester 4. Ads selected in this manner are referred to as interpersonal ads.

The ad recipient 8 can interact with the system 2 via client device, such as device 5b, to receive interpersonal electronic advertisements created by the ad suggester 4, such as ad 16. Suitable electronic devices that can be utilized by the ad recipient 4 or the ad suggester 8 can use to interact with system 2 include: a portable phone and/or phone number, a mobile device, a tablet, a thin client, a laptop computer, a netbook computer, a portable music player, a television, a cable display device, a desktop computer or any other electronic device configured to send and receive electronic transmissions or communications.

Data storage 30 can include hardware and/or software for storing information related to system 2. Data storage 30 can store information relating to the creation or provision of electronic advertisements. In specific embodiments, data storage 30 can include information relating to one or more of: a) a listing of advertisements 16, b) an entity that is related to each advertisement, c) suggesters 4, d) intended recipients 8, e) advertisement creation interface module 12, f) advertisement provision module 14, g) pointers to other websites or data locations that have products or advertisements, h) electronic advertisement input 10 and combinations thereof. Data storage 30 may include a database, a table, local hard disk memory, one or more RAM devices, memory available with conventional cloud computing techniques, or any means for storing information. In a specific embodiment, data storage 30 uses a relational database such those provided by Oracle Corporation of Redwood City, Calif. In another specific embodiment, data storage 30 employs an online database service, or Database-as-a-Service, (DaaS), such as those available from Microsoft Corporation of Redmond, Wash., or Amazon.com, Inc. of Seattle, Wash.

Within the system 2, the activities of both the ad suggester 4 and the ad recipient 8 can be tracked. In some instances, users of the system can be assigned one or more digital identifiers and the tracked activities can be associated with these one or more digital identifiers. In some embodiments, the system 2 can be configured receive information, such as a login and a password, that allow a user's identity to be verified and digital identifiers associated with the user to be located. After verification, activities performed by the user can be tracked and associated with their digital identifiers. Tracking information gathered by the system 2 can be stored to storage 30.

In one embodiment, the system 2 can store device information that is associated with an individual, such as the ad suggester 4 or the ad recipient 8 to storage 30. The device information can be associated with the individual when the individual regularly controls the device to interact with the system 2. Thus, when the device information for a particular device is detected, the system 2 can be configured to determine whether the device is associated with a particular individual. When the device is determined to be associated with a particular individual, activities performed using the device, such as 5a or 5b, can be associated with the individual. For instance, ad suggester 4 can register information about device 5a with the system 5a. When the system 2 detects device 5a, such as when a communication session is initiated with the device, the system 2 can determine device 5a is associated with ad suggester 4. Then, the system can be configured to attribute subsequent activities involving the system 2, such as an ad selection performed via device 5a, to ad suggester 4, or an ad view by the recipient, or activation by the recipient.

In particular embodiments, portions of the system 2 can be embedded in other systems. For instance, an ad creation interface module 12 can be integrated into a social media platform where the module 12 communicates with a remote ad provision module 14 in system 2 to provision ads to ad recipients. In this example, system 2 might also include its own ad creation interface module 12 separate from the embedded ad provision module. In another example, all the components of system 2 can be embedded in another system, such as a system associated with a social media platform. Many such configurations are possible and the example in FIG. 1 is shown for the purposes of illustration only. Further, functions attributed to each module can be combined or broken out in different manners and then the abstraction shown in FIG. 1 which is provided for the purposes of illustration only.

### Consumer Information in an Interpersonal Electronic Advertising System

As described above, an ad suggester, such as 4, can receive consumer information 6 from an intended ad recipient 8. As the term is used herein, consumer information 6 can refer to information relating to but not limited to a shopping need, recipient desire, a potential purchase, a recipient preference, an upcoming event associated with the recipient or a current or future location of the recipient. Examples of consumer information 6 include but are not limited to a) a product or service, b) price information, c) location information for recipient 8 or a store offering a product or service of potential worth to recipient 8, d) personal information related to a purchase such as a time or place of purchase, e) specific or approximate or general product and/or service information, etc. In a specific example, ad suggester 4 has knowledge that a friend recently purchased a house and wants to purchase a garage door opener that fits a garage door in the house. Consumer information 6 in this instance can include the knowledge of the friends recent house acquisition, their desire to purchase a garage door opener for his garage door, and maybe specifics on the garage door or when the recipient intends to purchase the garage door opener.

Consumer information 6 can be received directly or indirectly. The direct or in-direct communications of consumer information from recipient 8 to ad suggester 4 can involve non-electronic methods, electronic mechanisms, and combinations thereof. Non-electronic methods can include but are not limited to face to face conversations, a written note or observations of past purchases made by the recipient 8. A face to face conversation between the ad suggester 4 and the ad recipient 8 can result in a direct transmission of consumer information 6. Whereas, the ad suggester 4 can observe past purchases made by the ad recipient 8 to obtain consumer information 6.

Electronic mechanisms suitable for use herein, such as for a transmission of consumer information 6, can include a voice conservation enabled by an electronic device, an electronic message such as a text message or email from intended recipient 8 to suggester 4, a twitter feed from intended recipient 8 to suggester 4, one or more portions of an online chat conversation, one or more social networking posts, among others. For each of the electronic examples, an electronic device, such as a server, typically relays the consumer information 6 between the recipient 8 and suggester 4, and transmits the consumer information 6 to suggester 4. A direction electronic communication of consumer information 6 from ad recipient 8 to ad suggester 4 might involve the ad recipient 8 expressing a desire to purchase an item in a text message. An indirect electronic communication of consumer information 4 might involve ad recipient 8 posting a consumer need to person different from the ad suggester 4 and the ad suggester 4 viewing the post to obtain the consumer information 6.

As shown in FIG. 1, the transmission of consumer information 6 can occur via a communication channel outside of system 2. For instance, electronic device 5a and electronic 5b can enable voice communications between the ad suggester 4 and ad recipient 8 where the communications take place outside of system 2. In other embodiments, the system 2 can be configured with communication functions. For instance, system 2 can provide a chat function that allows the ad suggester 4 and the ad recipient to communicate and transfer consumer information 6. Thus, in some embodiments, although not shown, the consumer information 6 can be routed through system 2.

In more detail, as noted above, the ad suggester 4 can directly or indirectly receive consumer information 6 from the ad recipient 8. Indirect methods can involve observations that occur during the interactions or visits to the places where recipient lives or works. For instance, an ad suggester, such as 4, may notice that an ad recipient, such as 8, uses a particular product, such as a particular brand of shoes or a brand of a purse. Later, the ad suggester 4 may learn via a face-to-face conversation that the intended recipient is looking for a new purse or shoes. Based upon the consumer information they have indirectly learned, e.g., the ad recipient 8 may have never told the ad suggester 6 directly about the brand of purse they prefer, and the consumer information they have directly learned, the ad suggester 4 may select an ad for the ad recipient 8 via system 2.

As another example, an ad suggester 4 can obtain consumer information 6 when the ad suggester visits the ad recipient's 8 home. The recipient 8 may not even be present. While visiting, the ad suggester 4 may notice things about certain purchases the ad recipient 8 has made in the past. The observations the ad suggester 4 has made may later serve as consumer information 6 when the ad suggester 4 is selecting an ad, such as 16, for the ad recipient 8. In yet another example, the ad suggester 4 can overhear a conversation the ad recipient 8 is having with another individual (e.g., the ad suggester 4 and ad recipient 8 can live together with other individuals) and learn consumer information 6. Thus, through interactions that occur over time, an ad suggester 4 can be directly or indirectly gathering consumer information 6 from the ad recipient 8.

In other embodiments, consumer information 6 can relate to third-parties, such as individuals or groups known by the ad suggester 4 or ad recipient 8. For instance, if the ad recipient 8 is intending to purchase an item for another individual, consumer information 6 can include information about the individual that is to receive the purchase and/or information about the ad recipient 8. If the ad recipient 8 is intending to purchase an item for a group, the consumer information 6 can include information that the ad suggester 4 knows about the group and/or ad recipient 8.

In a father/son jewelry example, a son (ad suggester 4) can have knowledge that his father (ad recipient 8) has not purchased an anniversary present for the son's mother (third party, not shown). Consumer information 6 that the son possesses may include one or more of: i) information about an upcoming wedding anniversary, ii) specific jewelry product information that mother prefers, iii) the father's current location, iv) an anticipated price range, v) that father wants to do something nice for his mother, such as buy her jewelry, vi) other types of gifts the father has bought the mother on similar occasions or vii) combinations thereof. Thus, in this example, the consumer information 6 known by the ad suggester 4 (son) is related to the ad recipient 8 (father) and additionally a third-party (mother).

As described above, a relationship between suggester 4 and intended recipient 8 can improve intended recipient's 8 reception of advertisement 16. Depending on the relationship between 4 and 8, the intended recipient may activate ads, such as 16, at a higher rate as compared to ads received from other individuals or ads generated from context-based electronic advertising systems. After the ad recipient receives an ad from the ad suggester 4, activation of the ad can involve the ad recipient using system 2 to view the ad 16, select the ad 16, or purchase a product or service based on ad 16. As is discussed more below, the purchase of a product or service based on ad 16 can result in compensation for ad suggester 4 via compensation module 32.

In more detail, a perception of trustworthiness can exist between the two people interacting with system 2, such as 4 and 8. When the person 8 knows that certain consumer information 6 was given to suggester 4 in a trusted communication, person 8 then may expect ad 16, or welcomes the ad based on its source. An ad provided to ad recipient in this manner may be much better received than an ad, such as 16, from a non-trusted source, such as a business that the person 8 has no history of prior interaction, knows very little about the person 8 and has paid a search service the most money for an ad spot. Systems and methods described herein however enable intended recipient 8 to receive an electronic advertisement 16 from a known suggester 4. It is believed that factors, such as the trust between the ad recipient 8 and ad suggester 4 and consumer information 6 possessed by the ad suggester 4 that was ideally used in selecting an ad for the recipient 8, increase the likelihood that intended recipient 8 views and acts on the advertisement 16 when system 2 is employed.

The system 2 can be configured to receive electronic advertisement input generated on an electronic device, such as 5a. An interface, such as an interface implemented via a web-browser or a client application executing on the electronic device can be used to provide the electronic advertisement input 10 to system 2. In one embodiment, the ad creation interface module 12 can be configured to generate an interface on an external electronic device, such as 2, via a client application such as a web-browser. The electronic advertisement input 10 can include data related to an ad recipient 8, such as information that allows an interpersonal ad to be sent to the person, consumer information 6, and/or advertisement selection received by ad creation interface. The ad suggester 4 may use the interface to locate an ad associated with a particular product or service provider accessible on system 2. Thus, electronic advertisement input 10 can include information related to one or more of a company, a person, an entity, a vendor, a product, or a service.

The consumer information 6 can be reflected in a selection of an advertisement within the system. In addition, the system may allow a user, such as 4, to store consumer information 6 associated with particular individuals, such as anniversaries and product preferences. In one embodiment, this information can be stored in storage 30. Consumer information 6 entered as electronic advertisement input 10 can be stored and later retrieved when the ad suggester 4 subsequently interacts with the system 2.

### Ad Creation and Ad Provisioning in an Interpersonal Electronic Advertising System

As described above, the ad creation interface module 12 can support a GUI that allows suggester 4 to create an ad using their consumer information 6. The GUI can be configured to allow the user to view and select various ads that can be sent to the ad recipient 8. Businesses associated with these ads can have agreed to send compensation to system 2 when an ad from system 2 has resulted in a purchase. In one embodiment, the system 2 can be configured to notify a business when an ad associated with the business has been suggested by an ad suggester 4 for an ad recipient 8. The notification message can include information that identifies the ad as having been suggested using system 2. This information may allow the business to keep track of potential transactions that can result in compensation being sent to system 2.

In a specific example of involving the utilization of system 2, a son 4 can possess consumer information 6 that his father 8 wants to purchase jewelry for a wedding anniversary 6. The son 4 can establish a communication with system 2 via electronic device, such as 5a, after which an interface associated with system 2 can be generated on device 5a. As described above, the ad creation interface module 12 can support the generated interface. The ad creation interface module 12 can be configured to support an interface that is suitable to the type of electronic device 5a that is being utilized. For instance, a different interface with different capabilities can be provided for a smart phone as compared to a laptop computer.

Via the generated interface, the son 4 can create, select and/or send one or more ads 16 for the father 8 indicative of his consumer information 6. In addition, via the interface, the son 4 may enter consumer information 6, such as the father's anniversary. The system 2 can be configured to store this information and possibly later remind the ad suggester 4 of this upcoming event.

Besides sending the ad 16 directly to the father, other modes of allowing the father to view the ad are contemplated. In one embodiment, the system 2 can be configured to interact with a social media application that displays the son's profile page. The system 2 can be configured to display interpersonal ads to the son's profile page. When the father visits the sons profile page, the interpersonal ad 16 can be displayed to the father. In this manner, the father may learn about the detail. Further details of social media applications are described below with respect to FIG. 3.

After the ad 16 is sent and if the father 8 acts upon the ad 16, the system 2 can be configured (see FIG. 2) to allow the son 4 to be compensated directly or indirectly from a merchant or service provider where the father 8 made a purchase. The compensation module 32 can be configured to perform this function. As an example, a jewelry store associated with ad 16 can agree to pay a percentage of the purchase generated from ad 16 to system 2, such as 10% of the purchase. After receiving the money from the jewelry store, the son can be paid some portion of the money to the son. The participating store is willing to pay such advertising fees since, without the son's help and timely advertising input 10, the store might not have made this particular sale to the father 8. If it is determined the father 8 was drawn to the store as a result of receiving the ad 16, in some embodiments, the ad suggester 4 can be compensated in some manner even if a purchase isn't made. Compensation of ad suggester 8 is described in further detail below.

As described above, an interface supported and/or generated by module 12 can receive electronic advertisement input 10 entered by ad suggester 4. Again, suggesting an ad can refer to the process of providing input 10 that at least partially determines ad 16 including receiving specific input that leads to the selection of a specific ad 16. Using ad creation interface module 12, suggester 4 can provide input 10 that may include or more of: i) information related to the results from searching for an ad related to consumer information 6, ii) information related to the selection of an ad 16 from a list, ii) information related to identification of one or more recipients 8 for ad 16, iv) information related to entering key words and selecting input 10 or the ad 16 based on results provided in response by ad creation interface module 12 or v) combinations thereof. Suitable interface components to enable an ad creation by person 4 can include but are not limited to one or more of a: drop down box, search box, a scroll down bar, tool bar buttons, menus, text boxes that accept user input, check boxes and the like. In one embodiment, the interface components can be formulated as a GUI for output to an electronic device, such as 5a or 5b. These interface components can allow suggester 4 to suggest or specifically select one or more electronic advertisements, such as 16, from a set of advertisements available on system 2. Further, the interface component components can allow an ad suggester to view their progress related to suggesting ads, such as whether interpersonal ads that they previously sent have resulted in a purchase and associated compensation.

The advertisement provision module 14, or ad provision module 14 can refer to any device, system or tool within system 2 configured to send interpersonal ad 16 to intended recipient 8. Ad provision module 14 is communicatively connected to ad creation interface module 12 and can be configured to receive data representing or at least partially identifying ad 16 from ad creation interface module 12. Ad provision module 14 sends data that allows intended recipient 8 to view the advertisement 16 suggested by the suggester 4 in an electronic format. In general, ad provision module 14 sends any suitable data for displaying, representing, identifying, rendering or outputting an ad 16 on a device 8. In a specific embodiment, ad provision module 14 sends a jpeg image or other suitable graphics format for the ad 16 when the ad includes graphics data for display on an electronic device, such as 5b. In another embodiment, the ad provision module can send audio files that allow an audio description of the ad to be output.

In one embodiment, the electronic advertisement suggester selects a specific ad via the interface generated by ad creation interface module 12, inputs contact information for recipient 8, and ad provision module 14 relays this created ad to the recipient 8. In another embodiment, suggester 4 inputs contact information for recipient 8 but only suggests a general advertisement or topic related to the ad 16 that is eventually sent to the recipient 8. In this case, the suggester does not provide input that identifies a specific ad, but provides non-specific criteria that relates to a set of advertisements that fit the non-specific criteria. The advertisement input 10 in this case includes insufficient detail to identify an ad that will be sent. Instead, the non-specific input results in a set of advertisements that fit the non-specific criteria. This leaves ad provision module 14 to select a specific advertisement 16 that will be sent to the recipient. In this instance, the consumer information 10 provided by the ad suggester 4 allows the system 2 to act as an ad suggester.

It should also be appreciated that an ad selected by suggester 4 may not be the same advertisement 16 received by recipient 8. For instance if the ad has expired since it was created, the system can select a similar or related ad to send to the recipient 8. In one embodiment, if an interpersonal ad, such as 16, a specific deal and deal expires before the ad is converted, the system 2 can be configured to notify the ad suggester 4 that the interpersonal ad is no longer valid and/or notify the ad suggested of a related ad that is valid and can be selected.

An electronic advertisement 16 that is sent via system 2 can convey any commercial opportunity to recipient 8 or other message for a potential consumer transaction. Electronic advertisement 16 can include any format or data suitable for conveying the commercial opportunity to an ad recipient. The advertisement 16 can include one or more of video data, audio data, text, graphics information, or any combination thereof. Electronic formats suitable for conveying and delivering ad 16 include: an email, an instant message, a text message (SMS or MMS), in situ ad in a web browser, a weblog (blog), a social network environment, a news feed, a webpage, a status post, a twitter update, graphics for display on a display device, etc.

In one embodiment, the system 2 can be configured to allow the ad suggester 4 to personalize an interpersonal ad, such as 16. For instance, in the father and son jewelry example, the son can send a note to father saying, “I overheard mom talking about this item at the jewelry store.” This note can be displayed with the interpersonal ad 16 sent to the father. The note allows the father to confirm the relationship with the sender (son) and additionally provides consumer information 6 that can aid the father 8 in the purchase. The addition of the consumer information 6 may increase the likelihood that purchase associated with the ad 16 occurs.

Recipient 8 may view an ad 16 in a wide variety of digital communication environments. In one embodiment, a social network environment displays the ad 16. In another embodiment, ad 16 is displayed in an online chat, instant message, mobile application, text message, or email. Ad 16 may also be displayed in the space of the recipient's internet browser dedicated to displaying ads. This may be done for any web page visited by the ad recipient. Other display schemes are contemplated and ad 16 is not limited to any specific display arrangement for ad 16.

It is contemplated that some actions performed by intended recipient 8 may be performed while intended recipient 8 is not online For example, intended recipient 8 can receive advertisement 16 on a mobile device and subsequently travel to an offline location, e.g. a store, maintained by an advertiser, or an affiliate of the advertiser, such as a merchant, retailer, wholesaler, among others. Printed ads from a computer also permit an alternative to recipient 8 from needing to bring his electronic device to a brick and mortar participating store. The printed ad can include identifying information that allows the ad to be identified as an interpersonal ad from system 2. The recipient 8 may also use a mobile device to initiate and/or complete a transaction in an online marketplace or in a brick and mortar participating store. Such mobile commerce techniques are known to those of skill in the art. In one example, the recipient's mobile device digitally contains payment information, such as a credit card number. Participating storefronts or merchants permit the recipient to use the mobile device as a method of payment, such as using near field communication technology.

### Compensation in an Interpersonal Electronic Advertising System

System 2 can be configured to track what recipient 8 does in response to receiving ad 16. The tracked information can be used to attribute compensation to suggester 4. The tracking can include but is not limited to determining whether the recipient has acknowledged receipt of the ad, whether the recipient has visited a physical or virtual location associated with the ad and whether a purchase has resulted in response to receiving the ad 16.

In one embodiment, to determine whether an ad has resulted in a purchase, during a transaction for a product or service, recipient 8 may present an ad 16 where the ad 16 includes a bar code or other identifier for the ad 16 that represents advertisement redemption data that was originally supplied by the store. Further, the ad 16 can include information that links it to system 2. During a transaction where ad 16 is utilized, the recipient's device, such as 5b, and/or a device controlled by a merchant associated with an ad may then send a message to system 2 indicating that a transaction occurred. The system 2 can be configured to store this result to storage 30 as a successful ad suggestion for suggester 4. As is described in more detail below, information related to successful suggestions can be used to rank interpersonal ads that are displayed via system 2. The compensation module 32 can receive information regarding the successful ad suggestion and use it to attribute compensation to the ad suggester 4.

In one embodiment, the store, advertiser, affiliate, or intended recipient 8 can take action to provide information to the system 2 that verifies that a particular transaction occurred in response to electronic advertisement input 10. For example, the advertiser, affiliate or intended recipient 8 accesses a network and transmits notification of a successful consumer transaction made by recipient 8 relating to the ad 16 or digital coupon 16 suggested by suggester 4. In other embodiments, system 2 implements automated notification of a transaction by recipient 8 and a store based on ad 16. So long as system 2 receives affirmation of a consumer transaction relating to ad 16, then system 2 knows that the transaction occurred and may attribute a compensation to ad suggester 4 or another financial destination designated by suggester 4 (such as a bank account for a charity designated by suggester 4).

The compensation module 32 can be configured to attribute an incentive or compensation within interpersonal advertising system 2. Compensation can refer to any type of incentive, whether monetary, or in another form such as a discount on a present or future consumer transaction, coupon, merchandise, award, products, services, electronic tokens, virtual currency, rebate, among others.

Compensation module 32 can attribute compensation to a compensation destination designated by suggester 4. Module 32 can attribute compensation to ad suggester 4, such that compensation is accessible to the ad suggester. In another embodiment, compensation can be attributed to a destination specified by suggester 4, such as a charity for which suggester 4 is trying to raise funds. In this instance, the compensation may not be accessible to the suggester 4 once it has been attributed. However, the system 2 can be configured to maintain records accessible to the suggester 4 that indicate a number and an amount of compensation that has been attributed to entities other than the ad suggester 4.

To allow compensation, the system 2 can be configured to receive information, such as electronic payment information, that allows compensation to be transferred to an account specified by the ad suggester. For example, to enable personal compensation, an ad suggester 4 may provide a personal checking account number to system 2 via an interface generated or supported by the system 2, such as an interface supported by the ad creation interface module 12. The compensation enabling information can be stored to storage 30.

When it is time to attribute compensation to the ad suggester, the compensation module 32 can retrieve the previously specified payment information. For example, when payment information includes checking information, the compensation module 32 can subsequently deposit funds in the specified checking account using the retrieved payment information. In general, the payment information can be related to: a bank account, a PayPal™ account, Spare Change account, among others. Bank accounts may include personal accounts, business accounts, those for charitable organizations, etc. Digital credits and tokens are also suitable for use.

As noted above, compensation as contemplated herein is not limited to direct compensation of the ad suggester 4. For example, a grandparent may designate attributed compensation to the bank account for a grandchild. A suggester that supports a charity may designate the charity, or a specific bank account for a charity if known, as a financial destination for one or more ad revenues. Multiple people may also specify the same charity, thereby cumulatively generating significant funds for the charity only using actions by its supporters. Thus, the payment information input into system 2 can be associated with a financial destination that is not accessible to the ad suggester 4.

In particular embodiments, the system 2 can be configured to allow an ad suggester 4 to attribute compensation to a financial destination on ad by ad basis. For instance, the ad suggester 4 can designate that if a first interpersonal ad results in compensation the proceeds will be credited to the ad suggester and that if a second interpersonal ad results in compensation the proceeds will be credited to a third party, such as a charity. The system 2 can be configured to allow a user to view for each interpersonal ad the designated recipient of compensation that may result from ad and allow the user to change a previously specified designated recipient of an interpersonal ad.

Compensation module 32 can receive a notification that recipient 8 activated electronic advertisement 16. A component of system 2, such as module 32, may place or embed a tracking identifier and/or tracking program for an advertisement, such as 16. The identifier or tracking program can include a unique identifier or software used to track the status of the ad, such as an alphanumeric code, a hexadecimal string, a cookie, etc. Whenever recipient 8 activates the ad, that activation can be tracked by module 32. If a product or service is purchased, then recipient 8 pays the advertiser, vendor or seller, or an intermediary for either, and the advertiser, vendor or seller compensates electronic advertising provider 28 for that activation. In one embodiment, compensation module 32 uses cookies to track ad and purchase status or other recipient 8 activity in response to an ad 16.

FIG. 2 illustrates a method 101 for attributing an incentive or compensation within an interpersonal advertising system in accordance with a specific embodiment of the present invention. Method 101 begins by receiving a designation of a compensation destination (103) for compensation resulting from providing input for an interpersonal advertisement. Compensation may be attributed to any bank account or other suitable electronic compensation destination. For example, an ad suggester may provide a personal checking account number to the interpersonal ad service at 103. The payment information associated with the compensation destination can be used to subsequently send funds to the location specified by the payment information.

Next, in 105, an ad can be created by an ad suggester and the ad is sent to an ad recipient. Next, in 107, a notification that the ad recipient activated an electronic advertisement can be received. Activation of an electronic advertisement may include one or more of: 1) completing a transaction that was initiated using the interpersonal ad (e.g., the recipient was sent to a website to make the purchase using a link embedded in the ad 16), 2) completing a transaction that otherwise corresponds to interpersonal ad (e.g., the ad brought the ad recipient to a retailer's website, and the recipient purchased a product or service similar to the product or service conveyed in the electronic ad but not the particular product or service conveyed in the electronic ad), 3) acknowledging the interpersonal ad (e.g., opening an e-mail or text including the interpersonal ad), 4) visiting a physical or virtual location associated with the interpersonal ad or combinations thereof.

In one embodiment, the system can attempt to proactively or periodically verify whether the intended ad recipient has activated an interpersonal advertisement. If the recipient activated the interpersonal advertisement, then method proceeds to 111. If the intended recipient hasn't activated an interpersonal ad, after some time period, a check can be made again to determine whether an interpersonal ad has been activated. The system can continue make these checks until the verification returns an affirmative result or until the interpersonal ad is terminated.

As described above, a tracking number and/or tracking program can be embedded in an interpersonal ad. The tracking numbers can refer to one or more unique identifiers used to track the status of the interpersonal ad. When an interpersonal ad is in an electronic format, a tracking program can be embedded in the interpersonal ad. When the interpersonal ad is activated, the tracking program can be configured to report a unique identifier back to the interpersonal electronic advertising system.

Thus, whenever a recipient activates the ad, that activation can be tracked online and signaled to the interpersonal electronic advertising system. If a product or service is purchased and the recipient pays the advertiser, vendor, or seller, or an intermediary, the advertiser, vendor or seller can compensate the interpersonal electronic advertising system. Next, the proceeds can be divided between the ad suggester, an operator of the interpersonal electronic advertising system and possibly a third-party partner associated with the operator.

In one embodiment, electronic tokens, such as cookies, can be used to track interpersonal ads, a purchase status associated with ad and/or other recipient activity resulting from receiving the interpersonal ad. In a specific embodiment related to online use, cookies can be used in two stages of online recipient tracking: 1) at the load of the interpersonal ad and 2) when the interpersonal ad is clicked and the recipient that initiated the click is delivered to the seller or a website to make a purchase. Thus, the use of cookies can enable compensation for an ad suggester when the recipient activates an interpersonal ad. This compensation can be separate from the compensation that results if a purchase is actually made.

Next, in 111, compensation can be attributed to the operator of the interpersonal electronic advertisement system 2 described above in FIG. 1. In one embodiment, only the operator of the system and the ad suggester share the proceeds resulting from a successful purchase. The proceeds can be paid by a vendor that benefited from the purchase enabled by the ad suggester and the interpersonal ad provided by the interpersonal electronic advertising system. In a specific embodiment, the ad suggester and the system operator split the proceeds 75/25. In another specific embodiment, the ad suggester and system operator split the proceeds 33/67. Other splits are possible and are not limited to these examples.

In other embodiments, more than two parties can split the proceeds resulting from a successful ad suggestion. For instance, a social network site can host an ad creation interface. The ad creation interface can be coupled to the interpersonal electronic advertisement system. Proceeds associated with the activation of the interpersonal ads generated from the hosted interface can be split among the ad suggester, the operator of the social network site and the operator of the interpersonal electronic advertising system. In another specific embodiment, the electronic ad service provider receives compensation for providing the advertisement to the intended recipient, without any further activity by the recipient. If the ad was sent to the recipient via a social network, method 101 can attribute at least a portion of the compensation to the social network. If a purchase subsequently results from the ad, then additional compensation can be attributed to one or more entities that participated in the process leading to the purchase.

Next, in 115, compensation can be directed to the financial destination associated for the interpersonal ad. The financial destination may have been designated in 103. In one embodiment, in 115, a record of the suggester's electronic advertisement input and the interpersonal ad that corresponds to the input which was sent to the intended ad recipient can be stored. Further, the system can store a record indicating that the compensation has been attributed including information regarding the designated recipient of the compensation.

Compensation for a purchase may vary. In one embodiment, method 101 attributes compensation to an ad suggester based on a percentage of a transaction, where the percentage does not change over time. A compensation percentage that does not change between successive activated ads is referred to herein as a ‘flat rate’ compensation percentage. In the jewelry store example described above, the son may receive a flat rate compensation percentage for all of his interpersonal ads, such as 5%, therefore receiving 5% of the transaction price of his father's purchase at jewelry store.

In another embodiment, a variable compensation structure can be implemented. For example, an ad suggester can be paid a higher compensation percentage on their first ad that is successfully acknowledged by an ad recipient, or their first ad that successfully resulted in a purchase by the ad recipient. The higher initial compensation might be used as incentives in order to enlist new ad suggesters to utilize the system. After the first ad is acknowledged and/or results in a subsequent purchase, a second compensation percentage (e.g., a lower flat rate) can be implemented for the ad suggester.

In another specific embodiment, the ad suggester can receive a compensation percentage until a minimum number of ads are sent, so as to provide initial incentive to utilize the interpersonal advertising system. After the minimum numbers of interpersonal ads are sent, the incentive structure can change, e.g., it can go to a flat rate or becomes variable according to the tiered system. In this second instance, once the minimum numbers of ads are sent, the system can be configured to change the incentive in relation to the number of successful activations. In this manner, an ad suggester receives a first compensation percentage for an initial threshold number of ad suggestions, and receives a variable rate of return, as further described above, once the initial threshold is met.

In some embodiments, the dynamic rate of return does not fall below the initial flat rate. For example, a sample incentive scheme offers compensation for the first twenty interpersonal ad activations at 5% of the corresponding transactions. The ad suggester's first interpersonal ad can be a jewelry store ad to his father. The father can activate the ad by using it at jewelry store in a consumer transaction. The total purchase price can be $500 where the ad suggester (son) son receives $25 since it was son's first interpersonal ad. The son can continue to receive this 5% rate for activations of his interpersonal ads until he provides twenty (or some other threshold) interpersonal ads that result in ad activations. Subsequently, another transaction scheme, such as a variable compensation scheme can be utilized.

Other compensation schemes are contemplated. In another embodiment, the compensation percentage varies in relation to the total amount of the transaction price. For example, the incentive rate for a $100 ski rack might be 5%. Thus, the ad suggester of the ski rack receives $5 dollars when a purchase results from the suggested. Whereas, the incentive rate for a $10,000,000 home purchase or yacht might be 1% and the ad suggester receives $100,000 dollars. In this manner, a business can control how much it rewards suggesters to bring customers to the business. In another compensation scheme, a flat fee for a purchase can be implemented that is irrespective of the purchase price or conversion rate or any other factor. For example, an ad suggester $3 can be paid for a certain ad that converts into a purchase by the recipient.

After attribution of compensation in 115, the 101 may repeat and return to 105 and new electronic advertisements can be sent to the recipient.

### Ad Suggestion Effectiveness Metrics

In the embodiments, described herein different metrics can be generated to characterize an ad suggester's effectiveness at suggesting ads to ad recipients. The ad suggester's determined effectiveness can vary from recipient to recipient. For instance, an ad suggester may be very effective at suggesting ads for their parents but not so effective at suggesting ads for their younger sibling. As another example, an ad suggester may be very effective at suggesting ads for their spouse but not so effective at suggesting ads for their adult children.

Besides from person to person, an ad suggester's effectiveness can be defined in many different ways. For instance, a metric of an ad suggester's effectiveness can be determined within different price ranges, such as effectiveness at suggesting ads for products between $1000 and $500 dollars as compared to ads for products between $100 and $50 dollars. As another example, a metric of an ad suggester's effectiveness over time can be determined. In yet another example, a metric of an ad suggester's effectiveness within product categories can be determined, such as travel products or furniture. Further, a metric of an ad suggester's effectiveness can be determined for ad suggested for a particular product. These metrics are provided for the purposes of illustration only and are not meant to be limiting.

The metrics listed above can be determined on a per person basis or on a group basis. For instance, an ad suggester's effectiveness at creating ads for products or services between $500 and $100 dollars can be determined for ads sent to a particular ad recipient over time. In another example, an ad suggester's effectiveness at suggesting ads for products and between $500 and $100 can be determined for interpersonal ads sent to a group of recipients over time. In yet another example, an ad suggester's effectiveness can be determine for interpersonal ads sent to recipients in particular age ranges, such as over 50 years of age or between 20 and 55 years of age. The metrics listed above can also be determined for different time periods, such as the last week, last month, last 6 months, last year, etc.

One metric for measuring an ad suggester's effectiveness at selecting interpersonal ads for ad recipients can be referred to as a conversion rate. In one embodiment, a first type of conversion rate can correspond to a total number of ad activations resulting in purchases relative to a number of interpersonal ads sent. In another embodiment, a second type of conversion rate can correspond to a total number of ad activations including activations resulting in purchases and activations resulting in non-purchases (e.g., the ad is selected, the ad recipient goes to a site displaying products associated with the advertisement and views additional advertising. However, the ad recipient doesn't purchase a product or service associated with the interpersonal advertisement.)

The conversion rate may be determined using a number of techniques and with a variety of inputs. For example, one suitable conversion rate can use a ratio of a number of prior interpersonal ad activations (purchase only) for a suggester related to the number of prior of interpersonal ads sent by the ad suggested over some time period. The conversion rate may be determined using statistics between: a) an ad suggester and ad recipient, b) an ad suggester and all his ad recipients, c) an ad suggester and a group of contacts (e.g., ski trip friends, or college friends, etc.), d) an ad suggester and his family and/or e) combinations thereof. In a specific embodiment, the conversion rate is a global conversion rate for all the interpersonal ads sent by a suggester and is determined at the time of sending an advertisement to the recipient. It is noted these types of determinations can also be utilized for other metrics associated with determining an effectiveness of an ad suggester and is not limited to the conversion rate.

Effectiveness metrics, such as conversion rates, can be used in the systems and method described herein for different applications. In one embodiment, effectiveness metrics can be employed in the compensation methods described above with respect to FIGS. 1 and 2. In another embodiment, the effectiveness metrics can be used for ranking ads. In the paragraphs that follow, the use of an effectiveness metrics in compensation schemes is described. The use of effectiveness metrics in ad ranking is described in the section below titled, “Ad Ranking.”

A variable rate of compensation tied to an effectiveness metric, such as a conversion rate, can be used within the interpersonal electronic advertising system to incentivize ad suggesters to provide electronic advertisement input and ads that are highly likely to result in purchases by recipients. It can also be used to disincentive spamming where a user tries to send a large number of interpersonal ads with a low probability of succeeding. Examples of utilizing a conversion rate in a compensation scheme are described with respect to the following paragraphs. When used in the method 101 described above with respect to FIG. 2, the conversion rate can be periodically updated so that a compensation percentage can reflect changes to the conversion rate.

In the jewelry store example, the conversion rate can be used to determine the son's compensation on his father's purchase. As described above, the conversion rate can be calculated in many different manners, such as on a per recipient basis or globally. For example, if the son in the jewelry example previously sent forty interpersonal ads and twenty were activated for purchases, then his conversion rate would be 50% interpersonal ads leading to purchases. If all forty of his ad suggestions were activated for purchases, the son's conversion rate would be 100%. As the son's conversion rate increases, the system can be configured to increase his compensation for a given activation. Likewise, as his conversion rate decreases, the system can be configured to lower his compensation. In this manner, son is incentivized to select interpersonal advertisements that are more likely to result in recipient activation. In one embodiment, if an ad suggester's rate becomes very low over some time period, e.g., the suggester is an ad spammer, the system can be configured to block the suggester from sending additional interpersonal ads.

In accordance with the example in the previous paragraph, the system can be configured to use a tiered conversion rate scheme to attribute compensation to an ad suggester. The tiered scheme can includes a number of tiers for the ad suggester's conversion rate, where each conversion rate tier conveys a dedicated compensation rate. Changes (up or down) to the ad suggester's conversion rate can cause their compensation to move between the conversion rate tiers and their predetermined conversion rate thresholds resulting in different compensation rates. Typically, a higher conversion rate tier results in a higher compensation percentage using the tiered system. For an increasing conversion rate, once the next conversion rate threshold number is reached, the system can be configured to increase the compensation percentage.

As described above, the conversion rate can vary over time. In one embodiment, a compensation percentage of the transaction can be based on the ad suggester's conversion rate at the time of sending the ad. In another embodiment, the compensation percentage of the transaction can be based on an average of the ad suggester's conversion rate at the time of sending the ad and the ad suggester's conversion rate at the time the ad is activated. In general, a conversion rate used to attribute compensation can be based upon conversion rates calculated at one or more times when compensation is being attributed for a particular interpersonal ad.

In a particular example, the conversion rate used to attribute compensation can be determined at the time an ad is suggested. In the jewelry example, if the son's conversion rate is 19%, and he suggests a jewelry store ad to father, and father activates the jewelry ad, the ad activation, depending on how the conversion is calculated, can elevate the son's conversion rate above 20%. When the conversion rate tiers are set at 10% increments, such as 10%, 20%, 30%, 40%, etc., the new higher conversion rate indicates the son may possibly earn additional compensation. In this embodiment, however, the system is configured to determine conversion rate at the time the ad is suggested for the purposes of attributed compensation. Thus, since the son suggested the ad while his conversion rate was 19%, the system is configured to receive compensation based on the compensation structure for a 19% conversion rate. On future activated ads, however, the son is eligible for the higher compensation at the compensation rate given to the high tier at 20%, while his conversion rate remains above 20%.

A tiered conversion rate compensation scheme may employ any number of tiers, where each successively higher tier conveys an increased compensation percentage, and each tier having a threshold conversion rate to qualify for the increased compensation percentage. When the conversion rate decreases to below the threshold level for a tier, the suggester's compensation percentage decreases to correspond with the lower conversion rate tier.

As described above, an ad can be output via an interface that is configured to receive an input that indicates the ad has been acknowledged. For instance, via a GUI, an ad recipient can provide an input via an input device, such as a touch screen, a mouse or a track pad, that indicates a selection of the ad by the ad recipient. As another example, via an oral interface such as a digital assistant like Siri by Apple™ the ad recipient can request, verbally, information about the interpersonal ad. In response, the digital assistant can output a verbal description of the interpersonal advertisement. In yet another example, an eye tracking device can be used with a GUI to determine whether a user has looked at an advertisement. The tracked position of the user's eyes such as if they lingered at a location of the interpersonal ad can indicate awareness of the interpersonal ad. The input received from an interface from which an interpersonal ad is output can be used by the system to determine the ad recipient has acknowledged the ad in some manner. In response to the acknowledgement of the interpersonal ad, the system can attribute compensation to the ad suggester. Further details of interfaces that can be used to output ads are described below in the following section.

### Interfaces for Outputting Interpersonal Ads

As described above, various types of interfaces can be used to output interpersonal ads derived from an interpersonal electronic advertising system. Many types of interfaces can be primarily graphical in nature. However, other types interfaces, such as interfaces that are primarily sound based, like an interface based upon verbal commands and verbal responses using a digital assistant like Siri from Apple,™ can also be utilized. Various input and output devices can be used to allow a user to interact with the interfaces. Examples of input devices that can be utilized include but are not limited to 1) touch sensitive devices, 2) sound detection devices that can include speech processing capabilities, 3) motion detection devices, such as devices incorporating cameras or accelerometers to detect motion to indicate inputs, and 4) mechanical devices such a keyboard or a mouse. Examples of output devices used with an interface can include but are not limited to video displays, sound generation devices that can include speech synthesis capabilities and haptic devices that generate detectable vibrations.

FIG. 3 illustrates a graphical user interface 201 for displaying a viewable page including one or more interpersonal ads, such as a page output via a web-browser. The interface 201 is configured to allow ad suggesters to contribute at least a portion of the content 45 that is displayed to the page. As shown, the page displayed by the interface includes locations 16a, 16b and 16c for the placement of up to three advertisements where one or more of the placed ads can be interpersonal ads. Other pages formats are possible and the example is provided for the purposes of illustration only. The content 45 displayed on the page can vary depending on the purpose or theme of the page.

In one embodiment, the viewable page can be owned by a particular individual. Ownership may allow the individual to change aspects of what is displayed on the page at a particular time. In some instance, the interface 201 can be configured to generate a viewable page with one or more of a contacts module 175, an ad creation interface link 205 a dashboard link 207. The contacts module 175 can include a list of individuals associated with the owner of the page. As described below, the interface 201 can be configured to allow a user to create ads for individuals or groups of individuals. In some instances, contact information for the individuals or groups of individuals can be retained in the contacts module 175.

A selection of the ad creation interface link 205 can cause interface 201 to generate a page that allows a user access a database of products and services that can be selected for particular ad recipients, such as individuals stored in the contacts module 175, to together create an ad. A selection of the dashboard link 207 can cause the interface 201 to generate a dashboard page that allows the user to assess a status related to the interpersonal ads they have previously suggested. For instance, via the dashboard page, a user can view information such as but not limited to a list of interpersonal ads they have previously sent, whether interpersonal ads have been activated and by who, ad suggestion effectiveness metrics, such as conversion rates related to the activation of interpersonal ads, past attributed compensation, etc.

In one embodiment, an interface for displaying interpersonal ads can be compatible with social media applications. When the interface 201 is used a social media environment, a portion of the content 45 that is displayed can be social media related. In other contexts, the content 45 displayed in the interface can be different. For example, if the interface 201 is used to access a web-site, the content 45 that is displayed can be consistent with a theme of the web-site.

In a specific embodiment, the interface 201 can output a social network profile page associated with a particular individual. In this case, the social network content 45 can include content personal to the individual. As an example, the content 45 can include news feeds, a status post, a news update, etc. of interest to the individual.

In one embodiment, the interpersonal electronic advertising system can be configured to allow an individual to suggest ads for visitors to their social network profile page that are displayed via interface 201. In this example, ads 16a, 16b and 16c can be interpersonal ads selected by the owner of the page. When other individuals with a relationship to the individual visit the page, the interface 201 allow the visitors to activate the displayed interpersonal ads, such as 16a, 16b or 16c. After the interpersonal ads are activated, the owner of the social network profile page (ad suggester) can be compensated. The compensation rewards the page owner's efforts related to suggesting ads, gathering consumer information and social networking activities.

In one embodiment, when a social profile page is visited, the same interpersonal ads are displayed to everyone. In other embodiments, the system is configured to customize the interpersonal ads to each visitor. Thus, the ad suggester can suggest ads that are for an individual ad recipient or a group of ad recipients that visit their page. When an individual visits the page, the system can be configured to identify the visitor and then determine whether there are any interpersonal ads for the individual from the owner of the page. In one embodiment, when the owner of a page visits their own page, the system can be configured to display ads suggested for them from other individuals and/or ads they can select for others.

In the jewelry example described above, the son can create a social profile page via interface 201. Then, the son can select an interpersonal ad for their father, such as the jewelry advertisement. The interpersonal ad can be delivered to the father via some communication mechanism, such as text or e-mail. In addition, when the father 8 visits his son's page, the system can be configured to identify the father and determine whether there are interpersonal ads just for the father or the father falls within any groups that have been designated to receive a particular interpersonal advertisement. As an example, the son's 4 interpersonal advertisements for his father can include a jewelry store interpersonal ad 16a, a new family computer interpersonal ad 16b, and a sports car interpersonal ad 16c. Thus, father 8 visits his sons social profile page and the father can view a number of interpersonal ads from his son, such as 16a, 16b and 16c. As noted above, the system itself can also suggest ads for the father.

In some embodiments, the number of interpersonal ads for the father can be greater than the number of ad locations available on the page. For example, a son may have selected ten interpersonal ads for their father. However, only three locations are available for displaying the ads. In this situation, the system can be configured to rank each of the interpersonal ads relative to one another and display the top three ads. Details of ad ranking are described in more detail below.

When someone else visits the son's social profile page, a different set of ads can be displayed. For example, when his mother visits his page, an interpersonal ad for books the mother wants can be displayed in ad 16a, an interpersonal ad for a new family computer displayed can displayed in ad 16b, and an interpersonal ad for a spa getaway package in ad 16c. In the example, the interpersonal ad for the new family computer is displayed to both the mother and the father. The son may have selected that the ad for the computer to be displayed to family members. Further, the son may have identified the mother and the father as family members to the system. When the mother or father logs onto the system, the system can determine that the father or the mother are family members and then determine the new family computer interpersonal ad is to be displayed to each of them.

In general, the system can be configured to allow an ad suggester to define groups and then suggest ads for the group. For instance, the system can be configured to allow the ad suggester to create a group and then populate it from their contacts using the contacts module 175. The system can be configured to allow the user to delete or modify the members in a particular group. In particular embodiments, the system can be configured to allow an ad suggester to select the same interpersonal ad for multiple different groups.

As an example, an owner of the page can select the ad creation interface link 205 and the interface 201 can display an ad creation interface page. Via the interface, an ad can be selected for a discount ski pass for a particular resort 16. Next, the interface 201 can be used to create and populate a group, such as “ski friends.” Then, the ski pass interpersonal ad can be selected for the group “ski friends.” When someone in the ski friends groups views the social network profile page via interface 201, the system can identify the person as being a member of the ski friends group and the interpersonal ad for the particular ski resort can displayed. The ad suggester can be compensated at least each time one of the friends in the group purchases a lift ticket via the advertisement.

The interface 201 is not limited to displaying only three ads. In general, the interface can be configured to output one or more ads. The number of ads that are displayed to a page can vary over time. In addition, the system can be configured to vary the size and the placement location of the one or more ads displayed to a page at a given time. Further, the system can be configured to vary the content and format of a displayed advertisement. For instance, at one time, the content and format of a first interpersonal ad for a product can include selected content formatted to be output as a video with sound. In another embodiment, a second interpersonal ad for the same product can include selected content to be output as a still image without sound.

Multiple interpersonal ads can be provided for the same product and the system can be configured to select from among the multiple ads to output via the interface. For example, at a first time, a first interpersonal ad 16a can be output for a particular product. Then, at a later time, the system can refresh the social media profile page and a second interpersonal ad for the same product can be displayed.

A particular number of ad spaces in which interpersonal ads are output can be specified for a particular page format. For example, in FIG. 3, the page is configured with 3 ad spaces. In some embodiments, the number of interpersonal ads for available for a particular page format can be less than or greater the number of ad spaces that are available for interpersonal ads. When the number of interpersonal ads is less than the number of ad spaces, in one embodiment, the system can be configured to suggest ads to fill the unallocated ad spaces. In another embodiment, the system can be configured to only display the one or more available interpersonal ads. For example, if only one suggested ad is available, then for the page in FIG. 3, only one interpersonal ad might be displayed in location 16a and the locations for 16b or 16c can be left blank or the only interpersonal ad can be displayed in all three locations. In yet another embodiment, the system can be configured to reformat the page to reduce or eliminate the unfilled ad spaces. For instance, if one interpersonal ad is available, then the interface can be configured to expand the size and/or rearrange the remaining components, e.g., ad 16a, content 45, contacts module 175, ad creation interface link 205 and dashboard link 207 such that at least a portion of the available space associated with 16b and 16c is filled by the other page components.

When the system determines that more interpersonal ads are available then ad spaces are available on page, in one embodiment, the system can be configured to adjust the format of the page to increase the available ad spaces. For instance, if four interpersonal ads are available for the page shown in FIG. 3, the system can be configured to adjust the format of interface 201 to include 4 ad spaces instead of 3. The re-formatted can involve rearranging and resizing various components on the page.

In another embodiment, when more interpersonal ads are available for a page then ad spaces the system can be configured to rank the ads. Based upon the rankings, the system can distribute the ads to the ad spaces available on a page provided by interface 201. For example, if the system determines ten interpersonal ads are available for the page shown in FIG. 3, then the system can be configured to rank in order each of the ten ads and then display the three highest ads to ad spaces 16a, 16b and 16c. Further details of Ad ranking are described with respect to the following section.

### Process Including Interpersonal Ad Ranking

A block diagram of a process 300 including ad ranking is described with respect to FIG. 4. The process 300 can be implemented within an interpersonal electronic advertising system as described herein. First, in 300, an ad output event 302 can be detected. In an ad output event 302, multiple interpersonal ads can be output via an interface to an individual. For example, as described above, a GUI can be provided which allows an individual to view a plurality of interpersonal ads that have been selected for them by other individuals. In one embodiment, the ad output event 302 can cause a plurality of interpersonal ads selected by the individual for one or more other individuals to be output. In another embodiment, the ad output event 302 can cause a plurality of interpersonal ads selected for the individual by one or more other individuals to be output. In yet another embodiment, the output event 302 can cause two separate sets of interpersonal ads to be output to the individual where a first set has interpersonal ads selected by the individual for other individuals and a second set has interpersonal ads selected for the individual by other individuals.

The ad output event 302 can include information about the individual for which the interpersonal ads are to be output, such as information about the identity of a visitor to a social network profile page or information about the individual currently utilizing the interface. An ad assembler 306 can receive the ad output event 302 including the information about the individual for which the interpersonal ads are to be output. Using the information about the individual, the ad assembler 306 can retrieve from an ad database 304 a first set of interpersonal ads 308. As an example, as shown in FIG. 4, the interpersonal ads 308 retrieved by the ad assembler 306 include twenty six interpersonal ads labeled A-Z.

The interpersonal ads 308 can be received by an ad filtering module 310. Based upon the filtering parameters 312 input into the ad filtering module 310, a number of ads can be removed from the interpersonal ads 308 to generate a second set of ads, filtered ads 314. In one embodiment, the individual to whom the ads are to be output can specify one or more of the filtering parameters 312. For example, the individual can specify to view or not view interpersonal ads from a particular individual, to view interpersonal ads for products within a particular price range and to view interpersonal ads for a particular category or categories of products.

The ad ranking module 316 can receive the filtered ads 314 and determine a rank value for each of the filtered ads 316. In one embodiment, the rank value can be determined prior to applying the ad filtering module 310. For example, ad ranking module 316 can be used to determine a rank value for the interpersonal ads 308. The rank value can then be utilized by the ad filtering module 310 to filter the interpersonal ads 308.

As an example of filtering including rank value, a threshold rank value can be specified. When the rank value of a particular interpersonal ad exceeds the rank value and other filtering parameters indicate the particular interpersonal ad is to be removed, the ad filtering module 310 can be configured to retain the particular interpersonal ad rather than removing it. In one instance, the rank value can be determined such that high value interpersonal ads have a high rank value. Thus, this filtering method can be used to retain high value interpersonal ads to output to an individual that might otherwise be removed according to a particular set of filtering parameters. Therefore, using this method, in some instances, the system can be configured to over-ride filtering parameters selected by an individual to which the interpersonal ads are to be output.

Returning to the ad ranking module 316, after receiving a set of interpersonal ads, the ad ranking module 316 can determine a rank value for each of the interpersonal ads in the sets. To determine the rank value, the ad ranking module 316 can receive created ad data 318, module parameters 320 and performance data 322.

The created ad data 318 can include information about each created ad received by the ad ranking module 316, such as but not limited to a value of purchase associated with the interpersonal ad, the individual that suggested the ad and a total ad commission associated with the interpersonal ad. The total ad commission can be an anticipated amount of money that a merchant is to provide when an interpersonal ad leads to a purchase of a product or a service. As described above, the total ad commission can be split between various entities, such as the operator of the interpersonal electronic advertising system and the ad suggester that selected the interpersonal ad.

Module parameters 320 can include information that affects the calculation of a rank value, such as but not limited to a particular rank value function to utilize when multiple functions are available to determine the rank value and parameters with variable values that can be used to alter a value generated from a particular rank value function. As an example, a first function can be utilized when the filtered ads 314 are to be output to an individual that is creating interpersonal ads to send to another individual and second function can be utilized when the filtered ads 314 are to be output to a recipient for which the interpersonal ads were created.

Performance data 322 can include data used to generate ad suggestion effectiveness metrics, such as a conversion rate. In some instances, the performance data can include already determined ad suggestion effectiveness metrics. For example, the performance data 322 for a particular interpersonal ad can be ad suggestion effectiveness metric between a specific ad suggester and ad recipient associated with the interpersonal advertisement. Further details of ad ranking module 316 including determining rank value are described below in the section titled “Ad Ranking Module.”

After the ad ranking module 316 determines a rank value for each of the filtered interpersonal ads 314, the filtered ads 314 can be arranged as a list. In one embodiment, the order of the list can indicate an order in which the ads are to output. Three examples of lists, 324, 326 and 328 are shown as being output from the ad ranking module 316. List 324 and 326 can be different because two different rank value functions or a common function with different values of function parameters were used to determine the rank value for the interpersonal ads in the list.

In one embodiment, the ad ranking module can be configured to add one or more duplicates of an interpersonal ad to a list. For example, list 328 includes a duplicate of the first interpersonal advertisement. Thus, two copies of the first interpersonal ad in lists 324 and 326 can be output before the second interpersonal ad in list 324 and 326 is output. The module parameters 320 can be used to specify whether the ad ranking module 316 is configured to duplicates ad.

In one embodiment, the rank value determined for each of the filtered ads can be used to determine whether or not to duplicate an interpersonal ad on a list output from the ad ranking module. The ad ranking module 316 can be configured to determine the rank value of each interpersonal ad and arrange the interpersonal ads in a list ordered according to the determined rank value. Then, the ad ranking module 316 can be configured compare the rank values of a first interpersonal ad relative to a second suggested, such as two adjacent interpersonal ads in a list. When the rank values differ by more than some threshold amount, such as a percentage amount, a duplicate of one of the interpersonal ads can be added to the list.

As an example, the rank values can be determined for each of the interpersonal ads in list 324. Then, starting at the beginning of the list 324, the ad ranking module can compare the first interpersonal ad on the list 324 to the second interpersonal ad on the list. Based upon the rank value, the first interpersonal ad can be determined to be much more valuable than the second interpersonal ad. In response, a duplicate of the first interpersonal ad can be added to the list resulting in list 328. In one embodiment, the duplicate of the first interpersonal ad can be assigned a rank value indicating it is less valuable than the first interpersonal ad, such as 15% or 25% less valuable. Then, the rank value of the duplicate of the first interpersonal ad can be compared to the next interpersonal ad on the list.

If the duplicate of first interpersonal ad is still determined to be much more valuable than next interpersonal ad on the list then a second duplicate of the first interpersonal ad can be inserted into the list and the second duplicate can be assigned a rank value. Again, the rank value of the second duplicate ad can be selected to indicate that it is less valuable than the first duplicate ad. The comparison can then be carried out between the second duplicate interpersonal ad and the next interpersonal ad on the list. The ad ranking module 316 can continue to insert duplicates in the list until the function indicates another duplicate is to no longer be added or a maximum amount of duplicates is reached. At this point, the ad ranking module 316 can advance to the next interpersonal ad on the list and compare it to the following interpersonal ad on list to determine whether a duplicate of the next interpersonal ad is warranted. In this manner, the ad ranking module 316 can progress through the original list.

The list from the ad ranking module 316 can be sent to the ad formatting module 330. The system can be configured such that the same interpersonal ad can be formatted in different ways. For instance, a first format available for an interpersonal ad can include only a still image and text, a second format of available for an interpersonal ad can include video and sound while a third format available for an interpersonal ad can include only sound. As another example, a number of formats available for an interpersonal ad can be associated with a particular theme, like a holiday theme for Christmas or the fourth of the July. The ad formatting module 330 can be configured to generate an interpersonal ad for output that is consistent with a particular theme based on received formatting parameters 332.

An interface that outputs the interpersonal ads can include different capabilities on different devices. For instance, the output interface that is generated on a mobile device with a small display can be different than the output interface generated to a desktop computer with a large display. The ad formatting module 330 can be configured to generate different interpersonal ad formats depending on the capabilities of the output interface receiving the interpersonal ads. In one embodiment, the ad formatting module 330 can receive one or more formatting parameters 332 that reflect the capabilities and resources associated with the output interface that is to output the interpersonal ads.

As described above, one or more interpersonal ads can be output via an interface simultaneously. The list determined from rank value from the ad ranking module 316 can be used to determine which of the suggested to display simultaneously. For example, page 340 generated from an interface is shown with locations 334, 336 and 338 for displaying three interpersonal ads. Initially, the first three interpersonal ads from a list can be displayed to the page 340. In the figure, as an example, the first three ads from list 326 are shown as being output on page 340.

In some embodiments, different locations on a page, such as 340, can be considered to be more valuable than other locations for the purposes of interpersonal ad placement. For instance, because location 334 on page 340 is larger than locations 336 and 338, and is at the top of the page, it can be considered more valuable than the other two locations. In one embodiment, the interpersonal ads considered most valuable can be mapped to the locations on considered most valuable on a page, such as 340, in accordance with their rank value. For instance, if location 334 is considered most valuable, 338 is considered second most valuable and location 336 is considered third most valuable, then the most valuable interpersonal ad on a list can be presented at location 334, the second most valuable interpersonal ad on the list can be mapped to location 338 and the third most valuable interpersonal ad on the list can be mapped to location 336.

An interface on associated page, such as 340, can be configured to allow a user to scroll through a list of interpersonal ads, such as one or more of lists 324, 326 and 328. During scrolling, the relative rank values according to the ordered list can be maintained. For instance, if scrolling is available at position 334, then scrolling in one direction starting can reveal, in order of the list, the interpersonal ads on the list. When scrolling is reversed, the interpersonal ads can appear in the reverse order according to the list. For example, scrolling starting with “L” from list 324 can reveal “S,” “Y,” “G,” etc. and scrolling in the other direction starting from “G” can reveal “Y”, “S” and “L.”

In particular embodiments, the interface can include functions that allow a user to jump to different locations of a list ordered according to rank value and then scroll up or down in the list from the entry point on the list. For example, the interface can be configured to allow the list 326 to be entered at the sixth position “D” and then scrolling can be initiated from the point. A search function or a function that allows a user to specify a particular position on an ordered list of interpersonal ads, such as 324, 326 and 328, can be utilized to jump to a particular position on list.

In one embodiment, an interface can be configured to automatically scroll through a list of interpersonal ads ordered according to rank value. For instance, at a first time, interpersonal ads “L,” “S,” and “G” can be displayed on page 340. Later page 340 can be refreshed and the interpersonal ad at 338 can move to position 334, interpersonal ad at 336 can move to position 338 and the next interpersonal ad, “Y” from list 326 can be placed at position 336. In another example, when the page 340 is refreshed, interpersonal ads “L,” “S,” and “G” from list 326 can be replaced with interpersonal ads “Y”, “A”, “D”, e.g., the next three interpersonal ads from the list. Automatic scrolling might be useful in the situation where all of the interpersonal ads on a list are of the relatively same rank value.

In another embodiment, when automatic scrolling is employed, the rank value can be used to determine a relative time that an interpersonal ad will remain on a page before it is updated with a new interpersonal ad. Thus, an interpersonal ad considered much more valuable can remain on the page much longer than a less valuable interpersonal ad. For instance, if interpersonal ad “L” in list 324 is 10 times or more valuable than interpersonal ad, “S” and the other following interpersonal ads on the list according to their determined rank values, then when automatically scrolling is implemented, interpersonal ad “L” can remain over time tens time or more or longer on the page than the other interpersonal ads. Thus, while interpersonal ad “L” remains on the page 340, the other interpersonal ads from the list may be appearing and disappearing from the page 340 at a much faster rate.

### Rank Value Determination for Interpersonal Ads

Many methods can be utilized to calculate a rank value. In various embodiments, the rank value can be determined as a function of one or more of i) a total ad commission (TAC), ii) a global ad suggestion effectiveness metric (AS-GEM), iii) one or more ad suggestion effectiveness metrics between an ad suggester and an ad recipient (AS-AR EM), iv) whether an ad has previously used for a purchase (Ad Status), 5) whether an ad has been previously acknowledged by an ad recipient (Ad Clicks), 6) personal preferences of the ad recipient (PP-AR), 7) time, 8) weighting factors (WF) or 9) combinations thereof. Thus, rank value (RV) can be represented as,

RV=F(TAC,AS-GEM,AS-AR EM,Ad Status,Ad Clicks,PP-AR,time,WF, . . . )

Sample details of these parameters and example calculations using these parameters to determine rank value are described as follows.

The total ad commission can be the amount of compensation that a merchant offers for a purchase resulting from an interpersonal ad. For example, a total ad commission for a $1000 jewelry purchase can be $100 dollars. In one embodiment, the rank value function can be configured such that interpersonal ads with a higher TAC cause a more valuable rank value to be generated. Thus, if all the other parameters in the rank value function are held constant and only the TAC is varied, an interpersonal ad with a TAC of $100 dollars is given a more valuable rank value than an interpersonal ad with a TAC of $14 dollars.

The AS-GEM can be a metric that includes results from all interpersonal ads sent over a time period. For instance, if forty ads were sent to 5 ad recipients over some time period by an ad suggester and twenty resulted in purchases, the AS-GEM for purchases can be determined as the conversion rate which is 50%. In one embodiment, the rank value function can be configured such that an interpersonal ad from an ad suggester with a higher AS-GEM causes a higher rank value to be generated. Thus, if all the other parameters in the rank value function are held constant and the AS-GEM is varied, the rank value of an interpersonal ad from an individual with a higher AS-GEM can be ranked as more valuable than an interpersonal ad from an individual with a lower AS-GEM. For example, an interpersonal ad sent from a person with a 1% AS-GEM would be ranked as less valuable if the same interpersonal ad was sent from a person with 50% AS-GEM to the same ad recipient.

The ad suggestion effectiveness metrics between an ad suggester and an ad recipient (AS-AR EM) for each ad recipient can be higher or lower than the AS-GEM described in the previous paragraph. For instance, an ad suggester can possess an AS-GEM determined as a conversion rate of 30%. However, a first ad suggester may possess an AS₁-AR₁ EM with a first ad recipient, determined as a conversion rate, of 10% and an AS₁-AR₂ EM with a second ad recipient, determined as a conversion rate, of 50%. The rank value can be configured such that as the ad suggestion effectiveness metric increases, e.g., the ad suggester is more effective at suggesting ads to a particular ad recipient, the interpersonal ad is ranked as more valuable. For example, with all other aspects of the rank value function held constant, if at a first time an interpersonal ad is sent from an ad suggester to an ad recipient where the AS-AR EM determined as a conversion rate is 10% and later the same interpersonal ad is sent to the same ad recipient but the AS-AR EM determined as a conversion rate has increased to 50%, than the interpersonal ad sent at the first time would be considered less valuable than the same interpersonal ad sent at the second time when the rank value is considered.

As described above, many different types of AS-AR EMs can be defined. In different embodiments, different rank value functions can utilize different AS-AR EMs. In addition, the rank value function is not limited to using only one AS-AR EM at a time. Rank value functions can be configured that utilize two or more different AS-AR EMs in combination to calculate a single rank value for an interpersonal ad. For example, a plurality of AS-AR EMs can be calculated and then averaged for use in a rank value function.

It is assumed that as an ad suggester suggests more ads to additional ad recipients, the AS-AR EM approaches the AS-GEM and the AS-GEM is more likely to be a reflection of an ad suggester's consumer influence over a single ad recipient. Initially, when an ad suggester first starts suggesting ads, the amount of data used to determine these quantities is limited. In particular, until a first ad is suggested no data is available to calculate these quantities.

In particular embodiments, the AS-GEM or AS-AR EM values that are used in a rank value determination can be manipulated to account for a limited amount of data. In one embodiment, when a user first joins the interpersonal electronic advertising system, a default value can be assigned to AS-GEM and/or AS-AR EM. For example, these values can be set to a value of 0.5 to reflect a 50% ad conversion rate. The initial value that is assigned might be an average value determined from other users of the system with a similar demographic as the new user, such as user's within a similar age group, geographic area, educational level, gender, etc.

The effects of ad creation effectiveness metrics, such as AS-GEM and/or AS-AR EM, can be removed from the rank value determination during some initial time period. In one embodiment, during the first 60 days after a user joins the interpersonal electronic advertising system, the effects of the ad suggestion effectiveness metrics can be removed from the rank value determination. The effects can be removed independently of how many interpersonal ads have been selected and sent by the user in the initial period.

In another embodiment, during an initial period after a user has joined the system, the effects of the ad suggestion effectiveness, such as AS-GEM and/or AS-AR EM, are not considered in the rank value determination until a threshold number of interpersonal ads are sent by the user. When the threshold number of interpersonal ads is reached, even if it is during the initial period, then the system can be configured to start considering ad suggestion effectiveness metrics in the rank value determination. In a particular embodiment, if a new user doesn't suggest a particular number of interpersonal ads within an initial time period or the interpersonal ads selected during the initial time period don't result in purchases, the system can be configured to suspend the user's ad suggesting privileges and possibly close their account.

When an ad suggester first selects an interpersonal ad for a new ad recipient, there is no history of ad suggestion between the ad suggester and the ad recipient and hence an AS-AR EM can't be calculated. Even after the ad suggester has first suggested a few ads to the ad recipient, the determined AS-AR EM may not be considered to be accurate enough to use in a rank value determination. In one embodiment, when a number of interpersonal ads sent to an ad recipient by an ad suggester are below a threshold value, an AS-GEM can be utilized instead of the AS-AR EM. For instance, the first time an ad is suggested for an ad recipient by an ad suggester, the conversion rate of all the interpersonal ads they have sent over some time period can be used in a rank value determination to represent the conversion rate between the ad suggester and the ad recipient. As another example, when the new ad recipient is part of a group that is designated to receive an interpersonal ad from the ad suggester, the conversion rate between the ad suggester and other members of the group, such as a conversion rate for the group, can be utilized as the conversion rate between the new ad recipient and the ad suggester.

In particular embodiments, the AS-GEM can be used in lieu of the AS-AR EM in a rank value determination until the ad suggester selects some threshold amount of interpersonal ads for the ad recipient. For example, the AS-GEM can be utilized up until five interpersonal ads have been selected for the ad recipient. After five interpersonal ads have been selected for the ad recipient by the ad suggester, outcome data associated with the five interpersonal ads can be used to determine an AS-AR EM that can be utilized in a rank value determination. For example, a conversion rate based upon the outcomes of the first five ads can be used in a rank value determination for a sixth interpersonal ad between the ad suggester and the ad recipient. In addition, when a rank value is needed for the first five ads, a rank value determination for the first five ads that were calculated using the AS-GEM can now be calculated using the AS-AR EM instead.

In general, the formulation used to determine a rank value can vary from interpersonal ad to interpersonal ad. Formulations determining a rank value for an interpersonal ad can be determined 1) independently of an ad suggestion metric (e.g., during an initial time period when the ad suggester is first sending interpersonal ads), 2) as a function of an AS-GEM but not an AS-AR EM (e.g., there is not enough data between the ad suggester and the ad recipient) and/or 3) as a function of both an AS-GEM and an AS-AR EM (e.g.), when enough data is available, the rank value formulation can utilize both the ad suggestion effectiveness between a particular ad suggester and an ad recipient as well the ad suggestion effectiveness between the ad suggester and all the ad recipients for which the ad suggester has selected ads). Thus, when interpersonal ads received from a number of different ad suggester's are ranked for an ad recipient or when interpersonal ads sent to a plurality of ad recipients from an ad suggester are ranked, the rank value of a first interpersonal ad from a first ad recipient can be determined using a first formulation and a second interpersonal ad from a second ad recipient can be determined using a second formulation. In another example, a first rank value for a first interpersonal ad can be determined using a first formulation at a first time and a second rank value for the first interpersonal ad can be determine using a second formulation at a second time.

Different rank value formulations can be utilized for different products. For example, a first rank value formulation can be used for a car and a second rank value formulation can be used for an airline ticket. Ad recipient can receive the interpersonal ad for the car and the interpersonal ad for the from the same ad suggester where the rank value formulations used to determine the rank value for each interpersonal ad are different. Thus, the rank value formulations used to rank interpersonal ads from a single ad suggester can vary from interpersonal ad to interpersonal ad.

The examples of variation between rank value formulations described in the previous paragraphs are for the purposes of illustration only and are not meant to be limiting. Many different rank value formulations are possible and these different rank value formulations can be utilized when a rank value for a group of suggested are determined. When two different rank value formulations are compared, the different rank value formulations can include the effects of a different set of variables. Also, two different rank value formulations can include the effects of a same set of variables but the effects each variable can be determined differently. For instance, in a first rank value formulation an AS-AR EM doubled can be used to determine the rank value while in a second rank value formulation a square root of the AS-AR EM can be used to determine the rank value formulation.

The ad status parameter can be used to indicate whether an interpersonal ad has previously resulted in a compensated purchase. In one embodiment, the ad status parameter, as used in the rank value function, can be used to decrease the value of an interpersonal ad when it has been previously used for a purchase. For example, during a first visit to a person's social network profile page, a visitor can view an interpersonal ad from the person. Then, at a second time, after activating the interpersonal ad including making a purchase, the visitor can re-visit the person's page and a rank value for the interpersonal ad shown the first time can be recalculated. All other factors being held constant in the rank value function, the rank value determined for the interpersonal ad in the first visit can indicate the interpersonal ad is more valuable as compared to when the rank value is determined in the second visit. If the interpersonal ad is part of a list ordered according to rank value and rank value of the other ads doesn't change between the first and second visit, then the interpersonal ad may be in a lower position on the list in the second visit as compared to the first visit.

In one embodiment, the ad status parameter can be product dependent. For instance, certain products can be purchased more frequently than others. For instance, a person may purchase a pair of shoes much more often than a car. For products or services that are bought more frequently than others, the effect of the ad status parameter on the rank value can be less as compared to products or services that are bought less frequently. For example, the effect on the rank value from the ad status parameter in the rank value function after purchase of car can be much greater than the effect on the rank value from the ad status parameter after the purchase of a pair of shoes because it is more likely a person is going to buy another pair of shoes before they buy another car.

The ad clicks parameter can be used to indicate whether an ad recipient has previously acknowledged an interpersonal ad. For instance, when the interpersonal ad is displayed in a web-page an ad recipient can “click” on the interpersonal ad using an input device, such as a mouse. In one embodiment, an ad click can be interpreted as interest in the interpersonal ad by an ad recipient. In this interpretation, the rank value function can be configured such that an interpersonal ad with a rank value is considered more valuable and hence more likely to be displayed after it has been previously selected by an ad recipient. In one embodiment, the increase in rank value can be proportional to the number of times an ad recipient has selected the interpersonal ad. However, some number of clicks, the ad status parameter effect in the rank value function can be configured such that the additional clicks have little or no additional effect on the rank value determined from the rank value function.

As an example, at a first time an interpersonal ad can be displayed and the ad recipient can click on the interpersonal ad but not initiate a purchase. At a second time, an event can occur where the ad recipient can again be shown the interpersonal ad, the rank value determined for the interpersonal ad the second time can indicate the interpersonal ad is now more valuable than when the rank value was first calculated for the interpersonal ad. The change in the rank value to make the interpersonal ad more valuable can increase the likelihood of the suggested being displayed in an interface and/or move the interpersonal ad to a location considered more valuable on the interface. An example of an Ad click function is described below with respect to FIG. 6 and its use in the calculation of a rank value is described below with respect to FIGS. 8A and 8B.

The PP-AR in the rank value function can be configured to lower or increase the rank value to make an interpersonal ad appear more or less valuable when personal preferences of the ad recipient are known. For instance, if it is known that the ad recipient has made five purchases of a particular brand of shoes within a particular price range and then an event occurs where the ad recipient can view an interpersonal ad for shoes different from the brand the ad recipient likes and in a significantly different price range than the ad recipient normally makes their purchase (e.g., much lower), than the PP-AR factor in the rank value function can be configured to generate a rank value indicating the interpersonal ad is less valuable than might have otherwise been generated. Conversely, when event occurs where the ad recipient is to view a number of interpersonal ads and one of the interpersonal ads is for a deep discount for the brand of shoes the ad recipient normally purchases, the PP-AR factor in the rank value function may be configured such that the rank value that is generated indicates the interpersonal ad is more valuable than would have otherwise been generated.

Weighting factors in the rank value function can be used to increase or decrease the effects of the previous described parameters in the rank value function. For example, if an ad suggester to ad recipient effectiveness metric (AS-AR EM) is based upon the ad suggester sending one hundred interpersonal ads to the ad recipient, this factor can be given more weight in the rank value function than if the AS-AR EM was determined based upon the ad suggester sending ten interpersonal ads to the ad recipient. In this example, the AS-AR EM can be the same in each instance and the same interpersonal ad may be utilized. However, the interpersonal ad rank value determined using the AS-AR EM calculated based upon one hundred interpersonal ads can lead to a rank value indicating the interpersonal ad is more valuable than if the rank value is calculated using the AS-AR EM based upon ten interpersonal ads. The interpersonal ad can be more valuable if it leads to a purchase. Weighting factors can be applied to each of the previous parameters and this example with respect to AS-AR EM is provided for the purposes of illustration only.

As described above, one or more parameters used to calculate a rank value in a rank value formulation can be varied as a function of time. In one embodiment, time can be measured for each interpersonal ad from a time that the ad was created or sent. This time can be determined on an interpersonal ad by interpersonal ad basis. The time since the interpersonal ad was created or sent can be used to adjust the rank value that is determined for each interpersonal ad. In some embodiments, the rank value for an interpersonal ad can be adjusted as a function of time so that the likelihood of the interpersonal ad being displayed (e.g., a more valuable rank value) is increased at some times, and at other times so that the likelihood of the interpersonal ad being displayed (e.g., less valuable rank) is decreased.

In one embodiment, the system can be configured to allow an ad suggester to specify a time at which an interpersonal ad is to be sent. In this case, the ad creation time and ad sending time will differ. For example, the ad suggester may know that the ad recipient is on vacation and is not checking messages and/or is not likely to respond to an interpersonal ad. Thus, at the time of ad creation, the ad suggester may specify that an interpersonal ad not be sent until the ad recipient returns from their vacation. In another example, an ad suggester may know that an ad recipient tends to do their on-line shopping at a specific time, such as in the evening. Based upon this consumer information, the ad suggester may specify that an interpersonal ad be sent during this time period or just prior to the time period. In these examples, the time since the interpersonal ad is sent may not include the delay period between ad creation and ad sending, and the time measurement used in a rank value formulation can be determined from the actual time the interpersonal ad is sent and not the time the interpersonal ad is created. In other embodiments, the delay period between ad creation and ad sending may be included in the time measurement that is used in a rank value formulation.

In particular embodiments, the system can be configured to determine whether an ad recipient is available to receive an interpersonal ad. For example, the system can be configured to determine whether an ad recipient is on-line or not on-line. This determination can be used to affect a determination of a time measurement to use in a rank value formulation. For example, when the system determines an ad recipient is off-line when an interpersonal ad is first sent and then later determines the ad recipient is on-line, the system can be configured to determine a time since the interpersonal ad was first sent starting from the time when the ad recipient is first determined to be on-line. If the system determines the ad recipient is on-line when an interpersonal ad is first sent, then the time can be measured from when the interpersonal ad is first sent.

Different time measures can be used other than the time since the interpersonal ad was sent in a rank value formulation. For example, a time can be determined starting from a time an interpersonal ad is first acknowledged by an ad recipient. For example, the ad recipient can view an e-mail in which the interpersonal ad is included, the system can receive information indicating the interpersonal ad has been viewed and a time can be measured starting from this time. The rank value as a function of time can be varied according to this time in lieu of or in combination with the time since the interpersonal ad has been sent. In general, one or more different time measurements can be specified and a rank value formulation can increase or decrease the effects from one or more different time measurements.

In some embodiments, a rank value formulation can be time independent. In yet other embodiments, a rank value formulation can include time independent and time dependent components. A few functions that vary with time that can be used in a rank value formulation are described as follows with respect to FIGS. 5A, 5B and 5C. In FIG. 5A, a rank value is adjusted as a function of minutes since a time the interpersonal ad is sent. In this example, the function, F 402, is formulated as,

F(min)=(60-min)*c1 where c1=10, and a minimum value of F(min)=1.

In one embodiment, this function can multiply the rank value. In other embodiments, a function of this type can be added to a rank value where the minimum value is allowed to go to zero or even a negative value over time.

In this example, the rank value is constructed so that as the rank value of an interpersonal ad increases, the interpersonal ad is considered more valuable and the interpersonal ad is more likely to be displayed. The function, F(min) 402, described in the previous paragraph is configured for a rank value formulated in this manner. In other examples, the rank value can be constructed such that as the rank value of the interpersonal ad decreases, the interpersonal ad is considered more valuable and the interpersonal ad is more likely to be displayed. Time-based functions can be configured that are compatible with rank value determined in this manner. For example, a rank value configured such that a lower score indicates a more valuable ad can be divided by the function shown in FIG. 5A.

Using the function in FIG. 5A, the rank value is increased a maximum amount immediately after an interpersonal ad is sent. The rank value then decreases in a linear manner until after 60 minutes after which time the function no longer affects the rank value because the value of the function is set to one. In other embodiments, a non-linear function can be utilized. For example, F(min)=(60-min^{x})*c1, where x is greater than 0, can be utilized. In addition, the function can be configured such that its effects occur over a longer or shorter time period. For instance, the function can be configured such that after 30 minutes the function no longer affects the rank value or after 90 minutes the function no longer affects the rank value (e.g., F(min)=30-min or F(min)=90-min where a minimum value of F(min)=1 can be used).

The maximum value of the function doesn't necessarily have to occur at time=0. For instance, the function can have a first value at time=0, increase to a maximum value at 30 minutes and then drop off in value such that the function has no effect on the rank value after 60 minutes. In FIG. 5A, the constant is set to 10. In other embodiments, the constant can be set to a lower or a higher value. A constant such as this type can be a parameter that is configurable within the system. Many such functions are possible and the example shown in FIG. 5A is provided for the purposes of illustration only.

With respect to FIG. 5B, a function that uses a time measured in hours, F(hours) 404, is shown. In this embodiment, this function can multiply the rank value. In other embodiments, it can be added to other components in a rank value formulation. The function is configured for use with a rank value constructed such that an increase in rank value indicates a more valuable interpersonal ad, e.g., higher ranked interpersonal ads have a higher rank value and are considered more valuable than interpersonal ads with a lower rank value. The function is formulated as,

F(Hour)=constant*[24-hour], where the minimum value is 1.

The function 404 is formulated such that after 24 hours it has no effect on the rank value. As compared to function 402, function 404 has less influence immediately after t=0 on the rank value. The function 404 can be varied in the manner described above with respect to function 402 (e.g., non-linear, affects felt over a longer shorter time period, etc.).

With respect to FIG. 5C, a function 406 that varies according to the days since an interpersonal ad has been sent is shown. The function 406 can multiply the rank value. In other embodiments, a function, such as 406, can be added to other components in a rank value formulation. It can also be constructed to work with a rank value that increases to indicate a more valuable interpersonal ad. In one embodiment, the function 406 can be formulated as,

F(Days)=[1-constant*Days], with a minimum value of 0.05.

In this example, the constant is 0.05. Thus, after 19 days a minimum value of the function is obtained. The function is formulated such that initially it has minimal or no effect on rank value when it is used to multiple other components in a rank value formulation. However, as the days pass, function 406 decreases the rank value. In this example, the rank value is decreased more and more by this function 406 for 19 days at which time a minimum value is reached. After 19 days, the effect from this function is constant. In alternate embodiments, the constant can be altered such that the minimum is reached in less or more days. Further, a lower or greater minimum value can be specified. As described above, the function 406 can be varied in a non-linear way and the example provided in FIG. 5C is for the purposes of illustration only.

Different rank value formulations can be used for different products or services. As an example, the minimum value that is reached can vary from product to product and/or the time to reach the minimum can vary from product to product. For example, the time at which the minimum value is reached for shoes can be reached faster than the minimum value for a car. The minimum value for shoes can be reached quicker because generally a person takes a shorter period of time to decide they need a new pair of shoes and then make the purchase as compared to a car. As example, F(Days) for shoes can equal [1-constant*days²] while F(Days) for cars can equal [1-constant*days]. As another example F(Days) for shoes can equal [1-5*days] while F(Days) for cars can equal [1-days].

In a particular embodiment, each of the functions, 402, 404 and 406, can multiply the rank value simultaneously. In another embodiment, a piece wise combined function can be utilized. For example, a single function that varies with time can be constructed where function 402 is used between t=0 and 1 hour, function 404 is used between t=1 hour and t=24 hour and function 406 is utilized between t=1 day and afterwards. When combined in this manner the functions can be constructed such that a continuous function is generated. For example, function 402 can be constructed such that its value matches the value of function 404 at time=1 hour and so on. In another embodiment, the functions, 402, 404 and 406, can be combined in a piece wise manner and then curve-fit to generate a single smooth function that varies as a function of time.

Besides time, the effects of ad clicks on the rank value can be considered. In one embodiment, it assumed that an event where an ad recipient acknowledges an interpersonal ad is considered as interest in the ad suggested by the ad recipient. For example, an interpersonal ad can be displayed in a GUI and then via the GUI, an ad recipient can subsequently activate the interpersonal ad using input device (e.g., the interpersonal ad can be selected by “clicking” on it with a mouse.) When the interpersonal electronic advertising system is able to detect the activation of the ad, it can be configured to utilize this information when determining a rank value for the interpersonal ad.

In an example where the rank value is formulated such that an increase in rank value indicates a more valuable interpersonal ad, a function can be constructed that multiplies other rank value components. The function can be constructed such as the number of ad clicks increases the rank value is increased. As an example, a function 408 can be formulated, as

F(Ad Clicks)=c1*(number of Ad clicks)+1, maximum value=c2

An example of F(Ad Clicks) is plotted in FIG. 6. For function 408, the first constant is c1 and the second constant is 25.

In this example, the function 408 has no effect on the rank value when no Ad clicks have been detected. For one or more Ad clicks, the function increases the rank value until a maximum value of 26 is reached after which additional Ad clicks have the same effect as the fifth Ad click Like the time based functions described above, function 408 can be non-linear and varied in a number of different ways. Thus, the example shown in FIG. 6 is provided for the purposes of illustration only and is not meant to be limiting.

In a particular embodiment, function 408 can also be affected by time, such as the time since the last ad clicked occurred. For example, an ad can be clicked a first time and then it can be clicked again a second time. The effect of the second click on rank value can be increased as compared to what is shown in FIG. 6 depending on the time since the first ad click. For instance, if the interpersonal ad is clicked a second time within five minutes of the first time the rank value for the interpersonal ad that is determined can be greater than if the interpersonal ad is clicked for a second time one month after the first click.

In general, other variables in the rank value formulation can also be varied as a function of time. For instance, an ad suggestion effectiveness metric can also include a time component such that at a first time an ad suggestion effectiveness metric is given more weight than at a second time. An example determination of rank value including the effects of a total ad commission, ad suggestion effectiveness metrics, time factors, whether a purchase has occurred or not and ad clicks is discussed in the following section with respect to FIGS. 7A, 7B, 7C, 8A and 8C.

The time that an interpersonal ad was created can also lower or increase the rank value to make an interpersonal ad appear more or less valuable. For example, with all other variables equal, an ad that was more recently created can be given a higher ranking than an older interpersonal ad.

### Example Rank Value Formulations

Many rank value functions formulations are possible that use one or more of the parameters described above. In a simple example, the total ad commissions for two or more interpersonal ads can be determined and the two or more interpersonal ads can be ranked on this factor only. Thus,

Rank Value (RV)=F(TAC)=TAC

In slightly more complex example, the total ad commission of the interpersonal ads can be multiplied by the global conversion rate (for all ad recipients) of the ad suggester that has selected the interpersonal ad where the global conversion rate is provided as a value between 0-1. Thus,

RV=F(TAC, AS-GEM)=TAC*F(AS-GEM), where F(AS-GEM) is between 0 and 1.

Getting more complex, the global conversion rate of the ad suggester that has created the interpersonal ad and the specific conversion rate between the specific ad suggester and the specific intended ad recipient can be used. These two quantities can be averaged and then the average value can be multiplied to the total ad commission for each interpersonal ad. Thus,

RV=F(TAC,AS-GEM,AS-AR)=TAC*F(AS-GEM,AS-AR)=[F(AS-GEM)+F(AS-AR)]/2, where F(AS-GEM) and F(AS-AR) are each between 0 and 1.

The generated rank value determined for each of the interpersonal ads using this formulation can be used to rank the interpersonal ads relative to one another. Although not shown, both linear and non-linear functions can be utilized in a rank value formulation. As more and more of the parameters described above are incorporated in the rank value formulation increasingly more complex formulations can be generated. Thus, the examples provided above are for the purposes of illustration only.

In a particular example, which is illustrated in FIGS. 7A, 7B, 7C, 8A and 8B, the rank value is formulated as,

$$\begin{matrix}RV = F ( TAC , T\_min , T\_hours , T\_days , Status , \\ Ad\_clicks , AS \text{-} AR EM ) \\ = TAC * AS \text{-} AR EM * F ( T\_min ) * F ( T\_hours ) * \\ F ( T\_days ) * F ( Status ) * F ( Ad\_clicks ) \\ = TAC * AS \text{-} AR EM * [ 60 - T\_min ] * 10 * [ 24 - T\_hours ] * \\ [ 1.05 * T\_days ] * F ( Status ) * [ 5 * Ad\_clicks = 1 ]\end{matrix}$$

where i) F(Status)=1 for no purchase from interpersonal ad and 0.1 otherwise, ii) the minimum value of F(T_min)=1, iii) the minimum value of F(T_hours)=1 and iv) the minimum value of F(T_days)=0.05.

In FIGS. 7A, 7B and 7C, the log based 10 of the rank value for the function in the previous paragraph is shown as a function of time. The rank value for an interpersonal ad is calculated with zero ad clicks, a status of no purchase and a total ad commission (TAC) of $1. The ad suggestion effectiveness metric is determined as a conversion rate of purchases to ads sent for previous interpersonal ads for this ad sender. In each of FIGS. 7A, 7B and 7C, four curves, 510, 512, 514 and 516 are shown where the conversion rates are 0.1, 0.2, 0.5 and 1 for each of curves 510, 512, 514 and 516 respectively.

The same curves are shown in each of FIGS. 7A, 7B and 7C. However, in each of the figures, different time periods are emphasized. In FIG. 7A, the rank value determination is plotted as a function of days. In FIG. 7B, the rank value plotted over the first 24 hours is shown. Finally, with respect to FIG. 7C, the rank value over the first hour is shown.

Referring to FIG. 7A, the effect of the increase in the conversion rate which is a constant and does not vary with time is to increase the rank value initially. However, after 19 days all of the curves, 510, 512, 514 and 516 converge to a common a rank value. In actual implementation, the conversion rate can vary as a function of time. Over time, the ad suggester can be sending more and more interpersonal ads to the ad recipient. Thus, the conversion rate can vary over time depending on the rate at which interpersonal ads are converted by the ad recipient.

As an example of the effect of varying conversion rate over time, if the conversion rate at time=1 minute is 0.1 then the rank value for the interpersonal ad can be determined from the value of 510 at 1 minute. If at two hours, the conversion is now 0.2 then the rank value can be determined from the value of 512 at two hours. Finally, if after 5 days the conversion rate is now 0.5, then the rank value can be determined from the value of 514 at 5 days.

In this formulation of rank value, a higher rank value can indicate the interpersonal ad is more valuable and is to be output first via an interface as compared to other interpersonal ads with lower rank values. The increase of the rank value with increasing conversion rate is desirable because it is assumed that interpersonal ads with higher rank values are more likely result in purchases. A purchase results in revenue that can be split between a user and an operator of the system. Whether a particular interpersonal ad is actually output will depend on the other interpersonal ads that are ranked with it. Nevertheless, using a rank value formulation as exemplified in FIGS. 7A, 7B, 7C, the interpersonal ads considered most valuable are more likely to be output first.

As can be seen in FIGS. 7A, 7B and 7C, the rank value is highest the first few minutes after it is sent and then drops the most in the first hour after it is sent. Between 1 hour and 24 hours, the rank value decreases at a slower rate than the first hour but faster than the next 18 days. Over the next 18 days, the rank value decreases more gradually and then each of the curves, 510, 512, 514 and 516 reach a common minimum after about 20 days.

In the examples shown in FIGS. 7A, 7B and 7C, the rank value of the interpersonal ads is emphasized in the first hour and the first 24 hours because it is assumed that the consumer information on which the interpersonal ads are based are most likely to be timely during these time periods. In other embodiments, different time periods can be utilized. For instance, the rank value of an interpersonal ad can be emphasized over the first week as compared to the first day or first hour as shown in FIGS. 7A, 7B and 7C (e.g., decrease in rank value that occurs over the first day or first hour can occur over the first week instead).

In one embodiment, the rate of change of the rank value as a function of time can depend on the total ad commission (TAC). Interpersonal ads with a higher TAC can be considered more valuable than interpersonal ads with a lower TAC. Thus, the rank value formulation can be configured such that interpersonal ads with a higher TAC are emphasized over a longer period time than interpersonal ads with a lower TAC. For instance, the drop in the rank value that occurs over the first hour in FIGS. 7A, 7B and 7C can be spread out over 3 days for an interpersonal ad with a high rank value. Whereas, the drop value that occurs over the 24 hours for an interpersonal ad with a low TAC can occur over the first 12 hours as compared to the first 24 hours as shown in Figures.

In yet another embodiment, an ad value formulation can be configured to accept additional consumer information input by ad suggester that can affect how long a particular interpersonal ad is emphasized according to its rank value. For example, the interpersonal electronic advertising system can be configured to accept a time period that the ad suggester estimates that a purchase is likely to take place. For instance, if the ad suggester inputs a week then the value of an interpersonal ad according to its rank value can be emphasized for a week and then quickly drop off. As another example, if the ad suggester inputs a day then the value of an interpersonal ad according to its rank value can be emphasized highly for a day and then quickly drop off.

In one instance, the system can be configured to accept purchase information from an ad suggester associated with the interpersonal ad. If a purchase of a product related to an interpersonal ad is made outside of the system, the system may not be able to determine that the suggested is no longer relevant. For instance, if an ad suggester sends an interpersonal ad to a friend for a first pair of shoes of a particular brand at a particular store and that day the friend purchases a second pair of shoes of a different brand at a different store, the interpersonal ad for the first pair of shoes may no longer be relevant. To account for the purchase, the system can be configured to accept an input from the ad suggester that indicates that the interpersonal ad is no longer to be emphasized according to its rank value. After receiving the input, when the rank value for the interpersonal ad is subsequently determined, the system can be configured to deemphasize the interpersonal ad according its rank value to a greater extent than if the manual input had not been received by the system.

Next, with respect to FIGS. 8A and 8B, additional rank values as a function of time are plotted as a function of time that illustrate the effects of ad purchases and ad clicks. In FIGS. 8A and 8B, a TAC of one dollar and a constant ad suggestion effectiveness metric of are used for each of curves of 514, 518 and 520. For 518, an ad click has been detected during the first hour. Thus, the rank value for 518 is increased as compared to 514 in which no ad clicks have been detected. For curve 520, a purchase has been detected during the first hour. Thus, the rank value for 524 is decreased as compared to 520 in which a purchase associated with the suggested has not been detected.

With respect to FIG. 8B, the rank value 522 as a function of time for a second interpersonal ad has been added as compared to FIG. 8A. The interpersonal ad in 522 uses the same parameters as the interpersonal ad in 514. However, the interpersonal ad in 522 has been sent three hours after the interpersonal ad in 514. Initially, the rank value of 522 is greater than the rank value of 518 for which an Ad click has been detected. However, after about an hour, the rank value of 522 drops below the rank value of 518 even though the interpersonal ad in 518 was initially sent three hours earlier (The differences between 514, 518 and 522 is that in 518 an ad click is detected in the first hour as compared to 514 and 522 in which no ad clicks have been detected and 522 has been sent three hours after 514 but otherwise utilizes the same parameters as 514.) The place where the cross over between 522 and 518 occurs depends on the rank value formulation. The cross over location can vary and the example shown in FIG. 8B is provided for the purposes of illustration only and is not meant to be limiting. Next, a method including ranking interpersonal ads is described.

### Method Including Ranking Interpersonal Ads

FIG. 9 is flow chart of a method 500 of outputting interpersonal ads via an output interface. In 502, an output event can be detected where a set of interpersonal ads is to be output to an ad recipient or ad sender. As an example, as described above, a first person can visit a second person's social network profile page where the social network profile page includes one or more locations where an interpersonal ad can be placed.

In 504, a set of interpersonal ads can be assembled. The identity of the ad recipient that is utilizing the output interface can be used to gather interpersonal ads that are relevant to the ad recipient. The set of interpersonal ads can include interpersonal ads selected by one or more different ad suggesters. In the social media example, the ad recipient can be a first person that is visiting the second person's social network profile page. The ad suggester can be the second person who is the owner of the profile page.

In 506, a rank value can be determined for each of the interpersonal ads in the set according to a rank value function. The rank value can be determined using parameters such as but not limited to 1) a total ad commission for each interpersonal ads, 2) a global ad suggestion effectiveness metric, 3) an ad suggestion effectiveness metric between the ad suggester and the ad recipient, 4) whether an interpersonal ad has been indicated as responsible for a purchase, 5) whether an interpersonal ad has been previously acknowledged, such as via a selection in a GUI, 6) personal preferences of the ad recipient, 7) time and 8) one or more weighting factors.

In 508, the interpersonal ads can be ordered in a list according to their rank value. In one embodiment, the first interpersonal ad on the list can be considered the ad that is most valuable and subsequent ads on this list can be considered less valuable. In particular embodiments, one or more of the interpersonal ads in the list can be duplicated based upon their rank value relative to other interpersonal ads on the list.

In 510, the interpersonal ads can be output via an electronic interface. The ads can be output according to their position on the list. In some instances, the output interface can be a GUI including one or more places for displaying an interpersonal ad. The interpersonal ads on the list can be greater than the number of places provided for displaying the interpersonal ad. In one embodiment, the interpersonal ads higher on the list ordered according to rank value can be output before interpersonal ads lower on the list until all of ad places in the GUI are filled.

### Network and Devices

FIG. 10 illustrates a diagram of a sample network 241 in which systems and methods consistent with the principles of the embodiments described herein may be implemented. Network 241 includes one or more clients 243 connected to one or more servers 245-247 via a network 249. Two clients 243 and two servers 245-247 have been illustrated as connected to network 249 for simplicity. In practice, there may be more or fewer clients and servers. Also, in some instances, a client performs a function of a server and a server performs a function of a client.

Clients 243 can be electronic devices, such as a personal computer, a wireless telephone, a personal digital assistant (PDA), a laptop computer, a mobile device, an mp3 player, a tablet, a television, a thin client, or any other type of computation of communication device, a thread or process running on one of these devices, or an object executable by one of these devices. One or more users (e.g., an ad suggester 4 or recipient 8) are associated with each client 243. Servers 245 and 247 include server entities that access, fetch, aggregate, process, search or maintain data in a manner consistent with the principals of the disclosure. Clients 243 and servers 245 and 247 connect to network 249 via at least one network interface that may include one or more wired, wireless, cellular or optical connections, or any other type of connection. The network interface relays communications to network 249. In one embodiment, clients 243 or servers 245 and 247 include a network interface dedicated to receiving input and a second network interface dedicated to send data to the network 249. In a specific embodiment, clients 243 or servers 245 and 247 includes a single network interface that both receives and sends data via the network 249.

In one embodiment, server 245 includes an advertisement system 251 useable by users at clients 243. Server 245 may implement an advertisement platform with advertisements from one or more vendors and sources, index the ads and store information associated with the ad data in a storage device. In some embodiments, server 245 hosts advertisements that are provided to users at clients 243. In one embodiment, ad system 251 provides an advertisement creation interface to clients 243. Via the interface, the ad system can provides a listing of ads that an add suggester can select. The system can be configured to receive electronic advertisement input. In some embodiments, the electronic advertisement input can be used in a search feature associated with the interface. The search feature can be used to locate particular ads that a user may wish to suggest. After ads are selected, ad system 251 can be configured to execute an advertisement provision function that allows an interpersonal ad to be sent an ad recipient. The ad recipient can access the interpersonal ads via one of the client devices.

Server 247 stores or maintains data that may be crawled by server 245. In one embodiment, the server 245 can store ad related data. Such data may include information described above for data storage 30.

Network 249 includes one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The telephone network may further include 3G, 4G, Mobile WiMAX, Long Term Evolution (LTE) or Long Term Evolution Advanced (LTE-A). The PLMN(s) may further include a packet-switched sub-network, such as, for example, General Packet Radio Service (GPRS), Cellular Digital Packet Data (CDPD), or Mobile IP sub-network.

While servers 245 and 247 are shown as separate entities, it may be possible for one of servers 245 or 247 to perform one or more of the functions of the other one of servers 245 or 247. For example, servers 245 and 247 may be implemented as a single server. It may also be possible for a single one of servers 245 or 247 to be implemented as two or more separate (and possibly distributed) devices. In addition, in some embodiments, one or more functions attributed to the servers 245 and 247 in the description provided herein can also be implemented on one of the clients or vice versa.

FIG. 11 illustrates a sample computing system 261, which may correspond to one or more of clients 243 and/or servers 245-247. Computer system 261 comprises a processor, or CPU, 263, input device 265, output device 267, communication interface 269, system bus 271, one or more main memory 273, ROM 275, BIOS 277, and storage device 279. System bus 271 permits digital communication between system processor 263 and ROM 275, as well as permits communication between other components within system 261 and processor 263 and/or ROM 275.

Processor 263 is a commercially available microprocessor such as one of the Intel, AMD or ARM family of chips, or another suitable commercially available processor. Processor 263 digitally communicates with ROM 275 via system bus 271, which may comprise a data bus, control bus, and address bus for communication between processor 263 and memory 273. CPU 263 is also coupled to the communication interface 269 by system bus 271 to permit data transfers to and from computing system 261.

System memory can include read only memory (ROM), such as 275. Other memories may be included or substituted for ROM 275, such as random access memory (RAM) 273. Computer system 261 may also include a storage device 279, such as a hard disk drive or an optical disk drive, for example. The drives and their associated computer-readable media provide non-volatile storage for system 261. A number of program modules are stored in the drives, ROM 275, and/or RAM, including an operating system, one or more application programs, other program modules, and program data. Although data storage above refers to a hard disk and optical disk, those skilled in the art will appreciate that other types of storage are suitable for use with a computer system, such as magnetic cassettes, flash memory cards, USB memory sticks, and the like. In addition, not all computer systems, such as PDAs and other portable devices include multiple external memory options.

Communication interface 269 provides an interface between CPU 263 and such peripheral devices as a display device, input device 265, output 267, network interface, and/or any other I/O device. For example, a mouse used as input device 265 digitally communicates with processor 263 through a serial port 269 that is coupled to system bus 271. Other interfaces, such as a game port, a universal serial bus (USB) or fire wire, may also provide digital communication between a peripheral device and processor 263. Output 267 may comprise one or more speakers employed by a headphone or speaker system. Input device 265 allows a user to enter commands and information into the computer system 261, and may comprise a keyboard, a mouse, a position-sensing pad on a laptop computer, a stylus working in cooperation with a position-sensing display on a PDA, a touch screen system, a microphone, a touch sensitive device or the like.

In addition to personal computers such as desktop computers and laptop computers, a variety of other computer systems and computer devices employing a digital processor, memory and a display device may implement techniques described herein. Handheld computers and other small portable digital devices such as cell phones and digital cameras are increasingly integrating video display and computer functionality. One current trend is hybrid entertainment devices that integrate the functionality of computer systems, phones, and gaming systems. Any of these devices may implement the advertising methods and compensation systems described herein. The scope of digital computer systems is expanding hurriedly and creating new devices suitable for use herein.

Embodiments of the present invention further relate to computer readable media that include executable program instructions for performing interpersonal advertisement techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

Interpersonal advertising and compensation system software and interfaces such as those described herein may be implemented using a number of computer languages and in a number of programming environments. One suitable language is Java, available from Sun Microsystems of Sunnyvale, Calif. Another suitable programming environment is the Ruby on Rails programming environment. Yet another suitable programming environment is the Microsoft Windows™ programming environment, which provides a series of operating systems suitable for implementing the present invention both on laptop computers and handheld computers. C or C++ are also suitable for use herein.

Although the foregoing invention has been described in some detail for purposes of clarity of understanding, those skilled in the art will recognize that various modifications may be made within the scope of the appended claims. In addition, although advertising has not been detailed for every type of electronic device, the present invention is suitable with any technology that provides electronic advertisements. The invention is, therefore, not limited to the specific features and embodiments described herein and claimed in any of its forms or modifications within the scope of the appended claims.

1.-10. (canceled)

11. A method of ranking interpersonal ads in an interpersonal electronic advertising system, the method comprising:
receiving in a processor a selection of an interpersonal ad from an ad suggester for an ad recipient;
at a first time, determining in the processor a first value of a time measure wherein the time measure is a period of time starting at earliest from when the interpersonal ad is first created;
determining in the processor a first rank value of the interpersonal ad based upon the first value;
outputting the interpersonal ad via an electronic interface in accordance with the first rank value;
at a second time, determining in the processor a second value of the time measure;
determining in the processor a second rank value of the interpersonal ad based upon the second value; and
outputting the interpersonal ad via the electronic interface in accordance with the second rank value.

12. The method of claim 11, wherein according to the determined first rank value as compared to the second rank value the interpersonal ad is considered more valuable at the second time than at the first time.

13. The method of claim 11, wherein according to the determined first rank value as compared to the second rank value the interpersonal ad is considered less valuable at the second time than at the first time.

14. The method of claim 11, further comprising:
determining an ad click has occurred between the first time and the second time and;
determining the second rank value based upon the determination that the ad click has occurred wherein an effect of the ad click on the second rank value is to make the interpersonal ad more valuable than if the ad click had not occurred.

15. The method of claim 11, further comprising:
determining a number of ad clicks have occurred between the first time and the second time and;
determining the second rank value based upon determination that the number of ad clicks have wherein an effect of the number of ad clicks on the second rank value is to make the interpersonal ad more valuable than if the ad click had not occurred.

16. The method of claim 11, further comprising:
determining a purchase deriving from the interpersonal ad has occurred between the first time and the second time and;
determining the second rank value based upon the determination that the purchase has occurred wherein an effect of the purchase on the second rank value is make the interpersonal ad less valuable than if the purchase had not occurred.

17. The method of claim 11, wherein the first time value is a difference in time between when the interpersonal ad is sent to the ad suggester and the first time and wherein the second time value is a difference in time between when the interpersonal ad is sent to the ad suggester and the second time.

18. The method of claim 11, further comprising:
registering at a third time the ad suggester with the interpersonal electronic advertising system;
determining a change in time between the third time and the first time;
determining the change in time is less than a threshold value;
determining the first rank value independently of an ad suggestion effectiveness metric between the ad suggester and the ad recipient;
determining a change in time between the third time and the second time;
determining the change in time is greater than the threshold value; and
determining the second rank value based upon the ad suggestion effectiveness metric between the ad suggester and the ad recipient.

19. The method of claim 11, wherein at the first time the first rank value is determined using a first rank value formulation and wherein at the second time the second rank value is determined using a second rank value formulation different from the first rank value formulation.

20. The method of claim 19, wherein the first rank value formulation does not include an effect of an ad suggestion effectiveness metric between the ad suggester and the ad recipient and wherein the second rank value formulation includes an effect of the ad suggestion effectiveness metric between the ad suggester and the ad recipient.

21. The method of claim 11, further comprising: determining the first rank value based upon a first value of an ad suggestion effectiveness metric at the first time and determining the second rank value based upon a second value of the ad suggestion effectiveness metric at the second time.

22. The method of claim 11, further comprising:
determining a first ad suggestion effectiveness metric between the ad suggester and the ad recipient based upon a portion of interpersonal ads resulting in purchase sent from the ad suggester to a second ad recipient different from the ad recipient;
determining the first rank value based upon the first ad suggestion effectiveness metric;
determining a second ad suggestion effectiveness metric between the ad suggester and the ad recipient based upon a portion of interpersonal ads resulting in purchases sent from the ad suggester to only the ad recipient; and
determining the second rank value based upon the second ad suggestion effectiveness metric.

23. The method of claim 11, further comprising:
determining at the first time a number of interpersonal ads sent from the ad suggester to the ad recipient;
determining that the number is greater than a threshold value;
when the threshold value is exceeded, determining an ad suggestion effectiveness metric between the ad suggester and the ad recipient based upon a portion of the number of interpersonal ads that have resulted in purchases; and
determining the first rank value based upon the ad suggestion effectiveness metric.

24. The method of claim 23, further comprising:
determining the threshold value is not exceeded,
determining a second number of interpersonal ads sent from the ad suggester to one or more other ad recipient different from the ad recipient; and
determining the ad suggestion effectiveness metric between the ad suggester and the ad recipient based upon a portion of the second number of interpersonal ads that have resulted in purchases.

25. (canceled)

26. A computer readable medium including instructions for determining ad ranking in an interpersonal electronic advertising system, the computer-readable medium comprising
computer code for receiving in a processor a selection of an interpersonal ad from an ad suggester for an ad recipient;
computer code for, at a first time, determining in the processor a first value of a time measure wherein the time measure is a period of time starting at earliest from when the interpersonal ad is first created;
computer code for determining in the processor a first rank value of the interpersonal ad based upon the first value;
computer code for outputting the interpersonal ad via an electronic interface in accordance with the first rank value;
computer code for, at a second time, determining in the processor a second value of the time measure;
computer code for determining in the processor a second rank value of the interpersonal ad based upon the second value; and
computer code for outputting the interpersonal ad via the electronic interface in accordance with the second rank value.

27. An interpersonal electronic advertising system, the system comprising:
a processor coupled to a memory and a network interface;
the processor configured to:
receive a selection of an interpersonal ad from an ad suggester for an ad recipient;
at a first time, determine a first value of a time measure wherein the time measure is a period of time starting at earliest from when the interpersonal ad is first created;
determine a first rank value of the interpersonal ad based upon the first value;
output the interpersonal ad via an electronic interface in accordance with the first rank value using the network interface;
at a second time, determine in the processor a second value of the time measure;
determine in the processor a second rank value of the interpersonal ad based upon the second value; and
output the interpersonal ad via the electronic interface in accordance with the second rank value using the network interface.

28. The system of claim 27, wherein according to the determined first rank value as compared to the second rank value the interpersonal ad is considered more valuable at the second time than at the first time.

29. The system of claim 27, wherein according to the determined first rank value as compared to the second rank value the interpersonal ad is considered less valuable at the second time than at the first time.

30. The system of claim 27, wherein the processor is further configured to:
determine an ad click has occurred between the first time and the second time and;
determine the second rank value based upon the determination that the ad click has occurred wherein an effect of the ad click on the second rank value is to make the interpersonal ad more valuable than if the ad click had not occurred.

31. The system of claim 27, wherein the processor is further configured to:
determine a number of ad clicks have occurred between the first time and the second time and;
determine the second rank value based upon determination that the number of ad clicks have wherein an effect of the number of ad clicks on the second rank value is to make the interpersonal ad more valuable than if the ad click had not occurred.

32. The system of claim 27, wherein the processor is further configured to:
determine a purchase deriving from the interpersonal ad has occurred between the first time and the second time and;
determine the second rank value based upon the determination that the purchase has occurred wherein an effect of the purchase on the second rank value is make the interpersonal ad less valuable than if the purchase had not occurred.

33. The system of claim 27, wherein the first time value is a difference in time between when the interpersonal ad is sent to the ad suggester and the first time and wherein the second time value is a difference in time between when the interpersonal ad is sent to the ad suggester and the second time.

34. The system of claim 27, wherein the processor is further configured to:
register at a third time the ad suggester with the interpersonal electronic advertising system;
determine a change in time between the third time and the first time;
determine the change in time is less than a threshold value;
determine the first rank value independently of an ad suggestion effectiveness metric between the ad suggester and the ad recipient;
determine a change in time between the third time and the second time;
determine the change in time is greater than the threshold value; and
determine the second rank value based upon the ad suggestion effectiveness metric between the ad suggester and the ad recipient.

35. The system of claim 27, wherein at the first time the first rank value is determined using a first rank value formulation and wherein at the second time the second rank value is determined using a second rank value formulation different from the first rank value formulation.

36. The system of claim 35, wherein the first rank value formulation does not include an effect of an ad suggestion effectiveness metric between the ad suggester and the ad recipient and wherein the second rank value formulation includes an effect of the ad suggestion effectiveness metric between the ad suggester and the ad recipient.

37. The system of claim 27, wherein the processor is further configured to:
determine the first rank value based upon a first value of an ad suggestion effectiveness metric at the first time and
determine the second rank value based upon a second value of the ad suggestion effectiveness metric at the second time.

38. The system of claim 27, wherein the processor is further configured to:
determine a first ad suggestion effectiveness metric between the ad suggester and the ad recipient based upon a portion of interpersonal ads resulting in purchase sent from the ad suggester to a second ad recipient different from the ad recipient;
determine the first rank value based upon the first ad suggestion effectiveness metric;
determine a second ad suggestion effectiveness metric between the ad suggester and the ad recipient based upon a portion of interpersonal ads resulting in purchases sent from the ad suggester to only the ad recipient; and
determine the second rank value based upon the second ad suggestion effectiveness metric.

39. The system of claim 27, wherein the processor is further configured to:
determine at the first time a number of interpersonal ads sent from the ad suggester to the ad recipient;
determine that the number is greater than a threshold value;
when the threshold value is exceeded, determine an ad suggestion effectiveness metric between the ad suggester and the ad recipient based upon a portion of the number of interpersonal ads that have resulted in purchases; and
determine the first rank value based upon the ad suggestion effectiveness metric.

40. The system of claim 39, wherein the processor is further configured to:
determine the threshold value is not exceeded,
determine a second number of interpersonal ads sent from the ad suggester to one or more other ad recipient different from the ad recipient; and
determine the ad suggestion effectiveness metric between the ad suggester and the ad recipient based upon a portion of the second number of interpersonal ads that have resulted in purchases.
